(19) United States
(12) Patent Application Publication
(10) Pub. No.: US 2018/0285910 A1
(43) Pub. Date: Oct. 4, 2018

(54) Interactive Promotional Competition Management System

(71) Applicant: Felix De Kleijn, Sondton (ZA)

(72) Inventor: Felix De Kleijn, Sondton (ZA)

(21) Appl. No.: 15/755,551

(22) PCT Filed: Aug. 31, 2016
(86) PCT No.: PCT/ZA2016/050032

§ 371 Date: Feb. 27, 2018

(30) Foreign Application Priority Data
Aug. 31, 2015 (ZA) 2015/06285

(51) Int. Cl. G06Q 30/02; G06Q 50/00; G06Q 50/34; G07F 17/32

(52) U.S. Cl. CPC G06Q 30/0209; G06Q 50/01; G06Q 50/34; G07F 17/3255; G07F 17/3213; G07F 17/3239; G07F 17/3258; G07F 17/3276; G07F 17/3274; G07F 17/323; G07F 17/3218

(57) ABSTRACT

This invention provides a competition management system 10 to administer promotional competitions. The system is configured to allow contestants 24 to participate in competing for rewards in the competitions. The system 10 comprises a host application server 12 programmed to receive, store and process competition data pertaining to multiple competitions each administered by a competition promoter 14 in accordance with competition rules. The system is configured to issue invitations to the client devices 26 of multiple social media friends of a contestant 24 to join the contestant 24 in the competition. The system 10 creates an association between the contestant 24 and her social media friends and is programmed to share rewards awarded in the competition between the contestant and social media friends associated with the contestant in accordance with predetermined reward sharing parameters.

### FIELD OF THE INVENTION

This invention relates to gaming systems and methods and more particularly to gaming systems involving progressive jackpots and social media interaction.

### BACKGROUND TO THE INVENTION

Promotional competitions have been quick to adopt the communication potential of online gaming platforms and online competitions currently constitute a popular promotional activity, with upwards of 10 million entries for some competitions in South Africa alone.

Promotional competitions differ from wagering, gambling and lottery-type competitions in that the latter require the participant to put up a consideration for the chance to win a prize at the risk of losing the consideration put up. In promotional competitions, entry is normally free and participants typically do not give up or risk anything to qualify for winning the prize. The persons participating in online promotional competitions are not competitors in the true sense, but there is nevertheless some form of contest, hence such participants will be referred to as “contestants” in this specification.

In the typical online promotional competition, the contestant is supplied with a unique code that the contestant must communicate to the competition operator or promoter, normally as part of a competition registration process. The communication means ranges from internet-connected computers using email to cellular network-connected devices such as mobile phones using appropriate network messaging protocols, such as chat applications or apps, Short Message Service (SMS) or USSD (Unstructured Supplementary Service Data, a protocol used in the GSM mobile telephony system to communicate between mobile phones and the computers of the service provider).

One aspect of this invention is the insight that current promotional competitions fail to exploit the full potential of the potentially communication-rich interface of online media. Once contestants submit their promotional code, they will most likely not hear from the competition promoter for some time after that. Current promotional competitions do not provide the competition promoter with much opportunity to communicate with contestants, since communication opportunities typically only arise when prizes are awarded. One technique competition promoters use to overcome this difficulty is to award frequent “instant” prizes. Instant prizes are typically constituted by low excitement, low communication value prizes like mobile phone airtime. Higher value prizes which have far greater communication value however, are conventionally awarded long after the contestant has entered the competition, when the competition has closed and there is a lucky draw, for instance.

A further aspect of this invention, therefore, is the provision of a system capable of keeping contestants actively involved with the competition and engaged with the brand and the product being promoted from the moment they enter the competition to the time that the competition expires.

### SUMMARY OF THE INVENTION

This invention provides a competition management system configured to host and administer multiple competitions each of which is configured to allow a plurality of contestants to participate in competing for rewards in the competition by means of system client devices operated by the contestants, the system comprising:
a host application server including programmable logic means programmed to receive, store and process competition data pertaining to multiple competitions each administered by at least one competition promoter on one or more system client devices operated by the promoter in accordance with predetermined competition rules;
a communications interface for the communication of data between the application server and system client devices operated by contestants, each including programmable logic means, a communications interface and a user interface;
the system being configured:
   to issue an invitation to the system client device of at least one social media friend of a contestant to join the contestant in the competition by way of a system client device operated by the social media friend;
   to create, in the host application server, an association between the contestant and the social media friend upon acceptance of the invitation by way of the system client device of the social media friend; and
   to share at least one of the rewards awarded in the competition between the contestant and at least one social media friend associated with the contestant in the competition in accordance with predetermined reward sharing parameters.

The competition management system may include means to allow the contestant to execute plays in the competition, the system using the contestant's system client device, the system being configured, upon execution of a play:
to award a reward to the contestant if, as a result of the executed play, the contestant fulfills the requirements of the competition rules for the reward; and
if, as a result of the executed play, the contestant does not fulfill the requirements of the competition rules for a reward, to determine whether a social media friend associated with the contestant fulfills the requirements of the competition rules for a reward; and
if the social media friend does fulfill the requirements of the competition rules for a reward, to award the reward to the contestant and the social media friend in accordance with predetermined sharing parameters.

In one form of the invention, the competition management system includes:
means to generate and issue a promotional code specific to a particular competition to a contestant in that competition;
means to permit the contestant, by way of the contestant's system client device, to participate in the competition by entry of the promotional code into the system and to execute plays in the competition;
means to derive a ticket code from the promotional code and to store one or more ticket codes as playing credits allocated to the contestant for purposes of playing the competition;
means to generate a random draw code each time the contestant executes a play in the competition;
means to compare the draw code to the contestant's stored ticket codes;
if the draw code matches a stored ticket code of the contestant, to determine that the contestant fulfills the requirements of the competition rules for a reward and award the reward to the contestant;
if the draw code does not match a stored ticket code of the contestant, to compare the draw code to the stored ticket codes of social media friends associated with the contestant;
if the draw code matches a stored ticket code of a social media friend of the contestant, to determine that the contestant and social media friend, in combination, fulfill the requirements of the competition rules for a reward and award the reward to the contestant and the social media friend in accordance with predetermined reward sharing parameters.

In this formerly invention, the system may include means to increment and decrement the playing credit allocated to a contestant in accordance with the competition rules, the system being configured to allow a competition promoter to include competition rules that allow a contestant to increment playing credits by inviting social media friends to play the competition collaboratively with the contestant.

In the preferred form of the invention, the system is configured to facilitate the administration of competition-playing contestants affiliated in groups that, together, play collaboratively in the competition, the system including a scheme of counters, comprising:
for each contestant in a competition, an individual counter that tracks the executed plays of that contestant in a competition, regardless of group affiliation;
for each contestant in a competition, a friends counter that tracks the executed plays of that contestants that contribute towards the total number of plays executed by all the contestants in the group;
one or more group counters, each derived by calculating the sum of the friends counters of all the contestants in the group, the group counter values being stored in one or more separate group counter registers; and
a competition totals counter which is derived by calculating the sum of the friends counters of all the contestants in a competition.

In this embodiment of the invention, the system is preferably configured to allow a competition promoter to include competition rules that restrict the award of rewards in the competition by the inclusion, in the system, of means to reset any one or more of the counters to a predetermined lower level.

The system, in the preferred embodiments of the invention, is preferably configured to accumulate a progressive jackpot as a reward, the system being configured to increment the value of the jackpot in predetermined increments over the duration of the competition.

This will allow a promoter to optimize the jackpot implementation so that the jackpot does not run out before the competition expires.

In this embodiment of the invention, the system is configured to include a variable jackpot as a reward, the system being configured to allow a competition promoter to implement a scheme of jackpot variables or “boosters” constituted by rules that require a contestant to fulfill predetermined requirements to vary one or either of the contestant's playing credits and the value of a reward in the competition, for instance by varying the value of the jackpot.

The competition management system is preferably configured to present a competition playing interface to the contestant on display means of the contestant's system client device, the playing interface being configured to resemble a three-reel slot machine playing interface, including three virtual spinning reels in a reels window and a virtual spin button configured, when pressed by a contestant in use, to cause the reels in the reels window to spin virtually.

In this embodiment of the invention, the playing credits are preferably stored and displayed as spin credits, the system being configured to decrement the contestant's spin credits with every press of the spin button and to prevent the contestant from playing the competition if the contestant's spin credits are exhausted.

In one specific embodiment of the invention, the system is constituted as a game management system configured to host and administer a progressive jackpot online slots game configured to allow a plurality of contestants to participate in competing for the jackpot in the game by executing plays on system client devices operated by the contestants each including programmable logic means, a communications interface and a user interface, the system comprising:
a host application server including programmable logic means programmed to receive, store and process game data pertaining to the game;
a communications interface for the communication of data between the application server and the system client devices operated by contestants;
the system being configured to issue an invitation to the system client device of at least one social media friend of a contestant to join the contestant in the game by way of a system client device operated by the social media friend and to create, in the host application server, an association between the contestant and the social media friend upon acceptance of the invitation by way of the system client device of the social media friend;
the system including programmable logic means configured:
   to issue a slots game ticket code to a prospective contestant to enable the contestant to play the game; preferably by way of a communications channel external to the system;
   means to increment the jackpot every time a slots game ticket code is issued to a prospective contestant;
   to permit the contestant, by way of the contestant's system client device, to participate in the game by entry of the slots game ticket code into the system and to execute plays in the game;
   to store one or more slots game ticket codes associated with the contestant;
   to generate a random draw code each time the contestant executes a play in the game;
   to compare the draw code to the contestant's stored slots game ticket codes;
   to determine, if the draw code matches a stored slots game ticket code of the contestant, that the contestant fulfills the requirements of the game rules for winning the jackpot and to award the jackpot to the contestant;
   if the draw code does not match a stored slots game ticket code of the contestant, to compare the draw code to the stored slots game ticket codes of social media friends associated with the contestant;
   if the draw code matches a stored slots game ticket code of a social media friend of the contestant, to determine that the contestant and social media friend, in combination, fulfill the requirements of the game rules for winning the jackpot and to award the jackpot to the contestant and the social media friend in accordance with predetermined sharing parameters.

Further embodiments of the invention will be described more fully below.

### BRIEF DESCRIPTION OF THE DRAWINGS

The invention will be further described with reference to the accompanying drawings in which:

FIG. 1 is a block diagram illustrating an exemplary system according to the invention;

FIGS. 2 to 8 are sequential flowcharts that illustrate one implementation of the system of the invention; and

FIG. 9 is a selection of screen displays (screenshots) illustrating an application user interface for a specific implementation of the system of the invention, the screen displays being intended for display on a contestant interface—individual screen displays are numbered 9A to 9YY.

Note: A number of trade marks are referred to in the drawings and in this specification. All rights in and to the trade marks belong to and vest in their respective proprietors. The applicant claims no right in these trade marks save to the trade mark THUMBINGO™ which is a trade mark of the applicant.

### DESCRIPTION OF EMBODIMENTS OF THE INVENTION

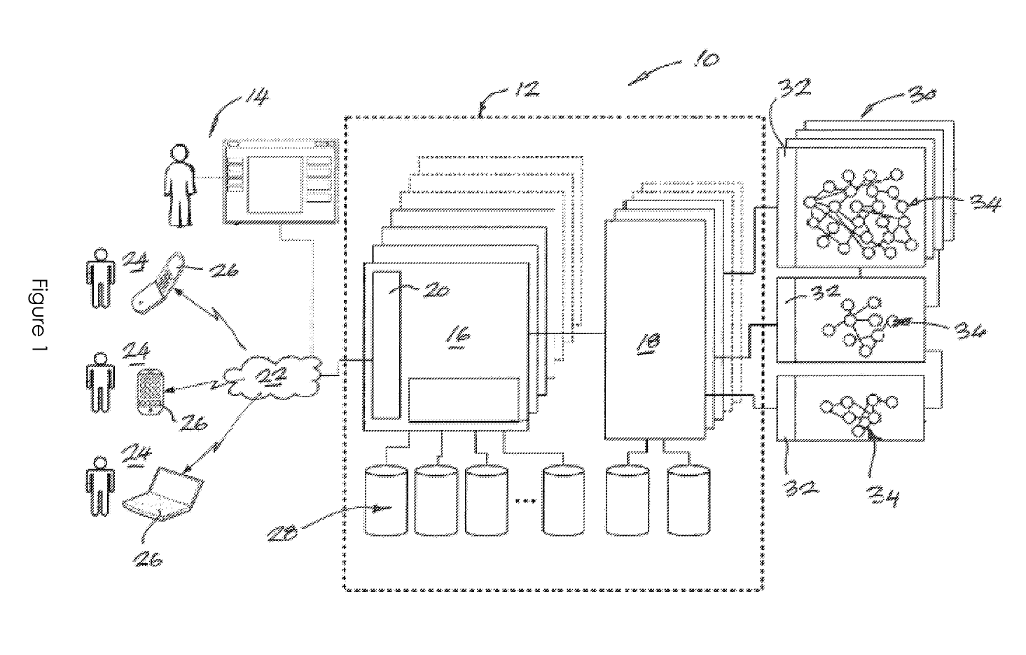

At its core, the system 10 (as illustrated in FIG. 1) comprises a host application server 12, which could be one or several computers that control the infrastructure required to host and administer a multiplicity of promotional competitions. The infrastructure includes a game server 16 and a social network management server 18 by means of which the users of the system 10 access and interact with the system.

The first set of users, includes a plurality of competition promoters 14 who conduct or promote competitions on the system 10. After registering on the system, the competition promoters 14 access the host server 12 to create and manage their own stand-alone competitions using functionality provided by the game server 16.

The competition promoters 14 access the game server 16 by way of a competition promoter front-end 20 connected to the internet 22. The competition promoter front-end 20 presents an administrative interface or promoter console 17 that includes the functionality required to enable each promoter 14 to develop, manage and administer a plurality of competitions.

The second set of users includes contestants 24, each of whom accesses the host server 12 by means of a client device 26.

The promoter console 17 allows promoters 14 to produce competition sites 28 on the system 10. To enable communication with various social networking services 30 such as Facebook™ and Twitter™, the host server 12 includes a plurality of Application Program Interfaces (APIs) 32—programs that manage the interface and communications between the host server 12 and the social networks 34. The social networks are independent networks managed by independent third party operators of the social networking services 30—Facebook™ by Facebook, Inc. Menlo Park, Calif., USA and Twitter™ by Twitter Inc. San Francisco, Calif., USA.

The competition promoters 14 will normally access the system 10 by means of system client devices constituted by internet-connected computers that connect with the system communications interface 20 by way of the internet backbone 22. Competition promoters 14 will need to register on the system 10 before they can participate. To do so, a competition promoter 14 will first register identity and financial information pertaining to the promoter 14 sufficient to allow participation in the system 10. Such registration will enable the promoter 14 to download and install promoter console application software obtained by downloading from the host server 12 or from an app store. The promoter console software programs the promoter's internet-connected computers to execute the promoter console software and to display the promoter console interface 17 on the promoter's computers, by means of which the competition promoters 14 are able to initiate and administer promotional competitions using the system 10.

Using the promoter console, competition promoters 14 are provided with the facility to create multiple promotion competitions, each accommodated within a dedicated competition site, illustrated in FIG. 1 as a plurality of competition databases 28 in which all programming and data pertaining to that competition is stored. The promoter console 17 gives the promoters 14 control access to the competition sites 28. Understandably, access to the competition sites is subject to security control so that each promoter 14 is restricted only to sites created and administered by that specific promoter 14.

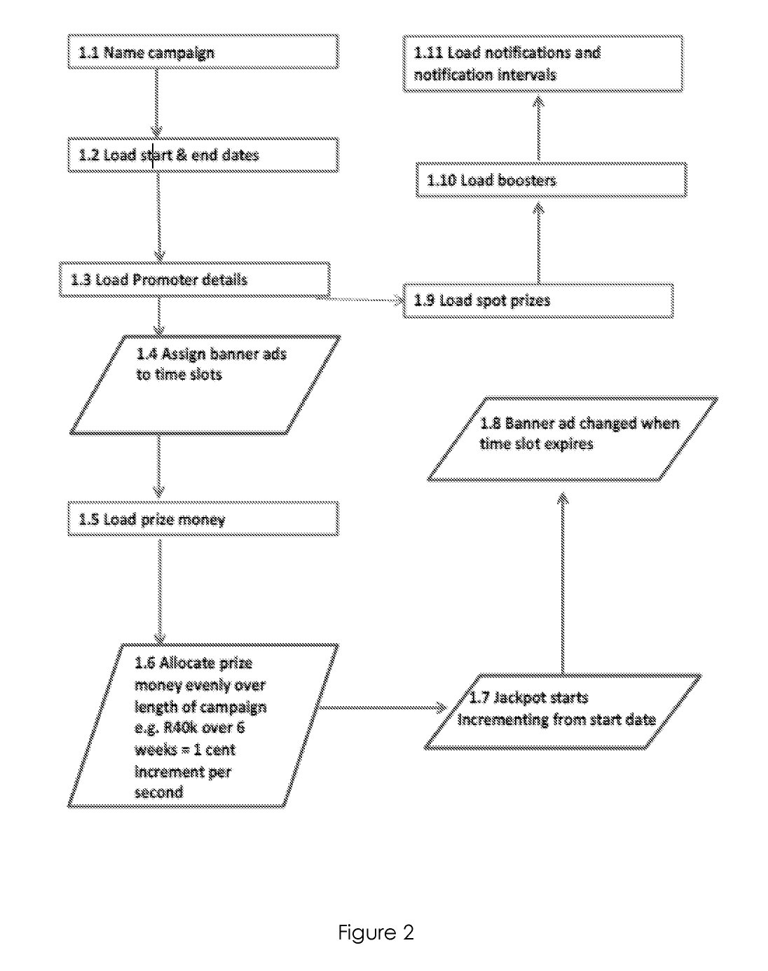

An example of a process for creating a competition site is set out in the flowchart of FIG. 2, in which the competition being created is referred to as a “campaign”. In the flowchart, certain process steps are numbered from 1.1 to 1.11. In brief, the process involves registering the competition by naming the campaign (1.1), loading the start and end dates of the competition or campaign (1.2), loading details of the competition promoter 14 (1.3) and loading prize details (1.5; 1.9; 1.10)—the spot prizes and boosters referred to in these flowchart items are described in more detail below.

In loading prize details, the promoter 14 loads the total amount of prize money and then applies a system algorithm to allocate prize money evenly over the length of the campaign (1.6). This aspect of the system 10 is described in more detail below as is the process of creating jackpots and incrementing jackpots (1.7). The competition promoter 14 is required to determine a number of intermediate time slots between the start and end of the competition (1.4) when banner advertisements will be called, displayed and changed during the course of the competition (1.8). In addition, the competition promoter 14 must determine a number of notifications and notification intervals (1.11) that will be displayed during the course of the competition. These features of the system 10 are described more fully below.

Contestants 24 access the system 10 by means of system client devices 26, which may be any suitable electronic device capable of implementing the functionality required of a client device for purposes of the system 10. Client devices 26 can include anything from desktop computers, laptop or notebook computers, or mobile or handheld computing devices, such as tablets and mobile phones, in each case enabled for communication using the internet 22 and the communications interface 20 of the system 10.

The client devices 26 are enabled for communication with the communications interface 20 and hence for participation in the system 10 by loading client device application software into the client device processor (not shown). The client device application software takes the form of a software application or app typically obtainable by downloading from the host server 12 or from an app store.

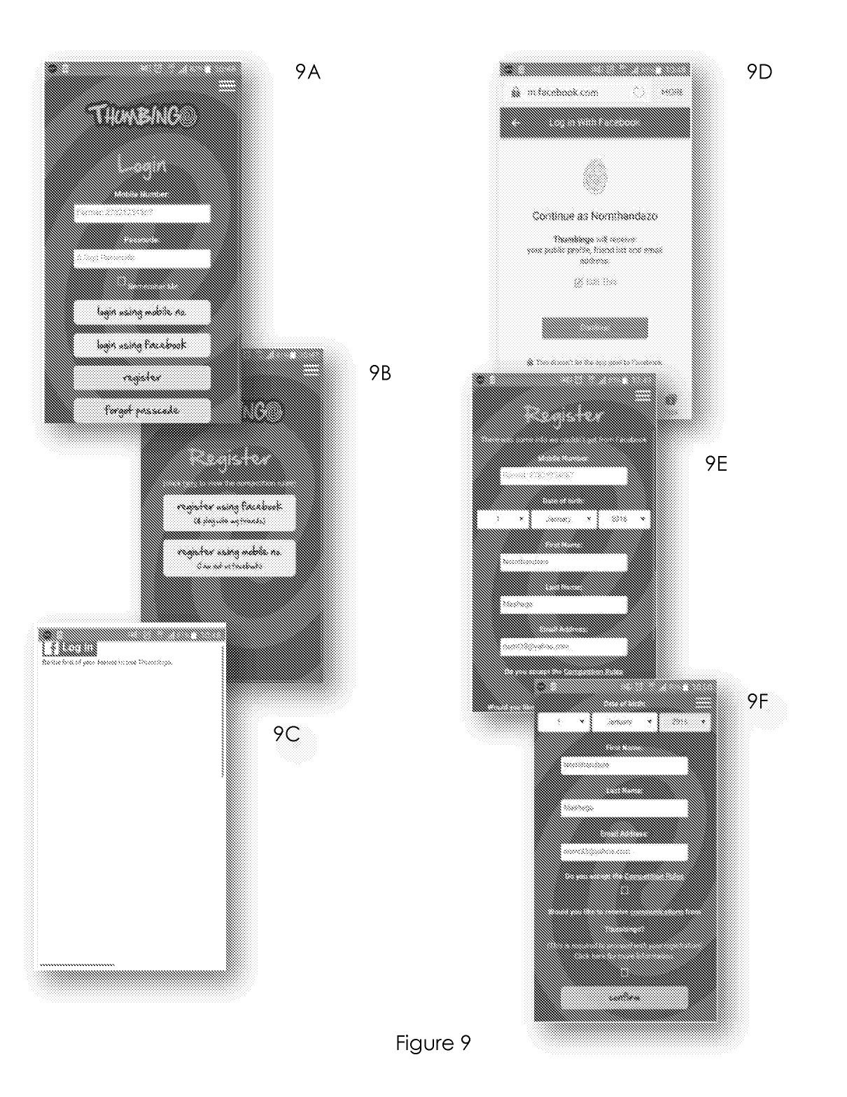

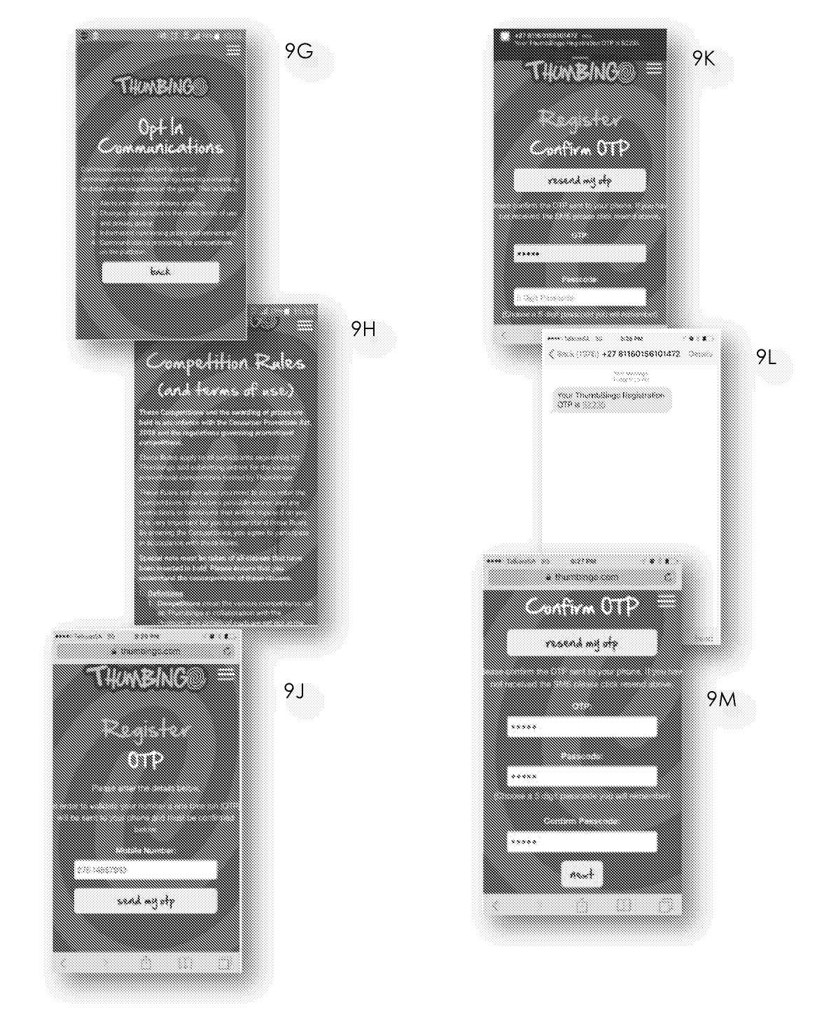

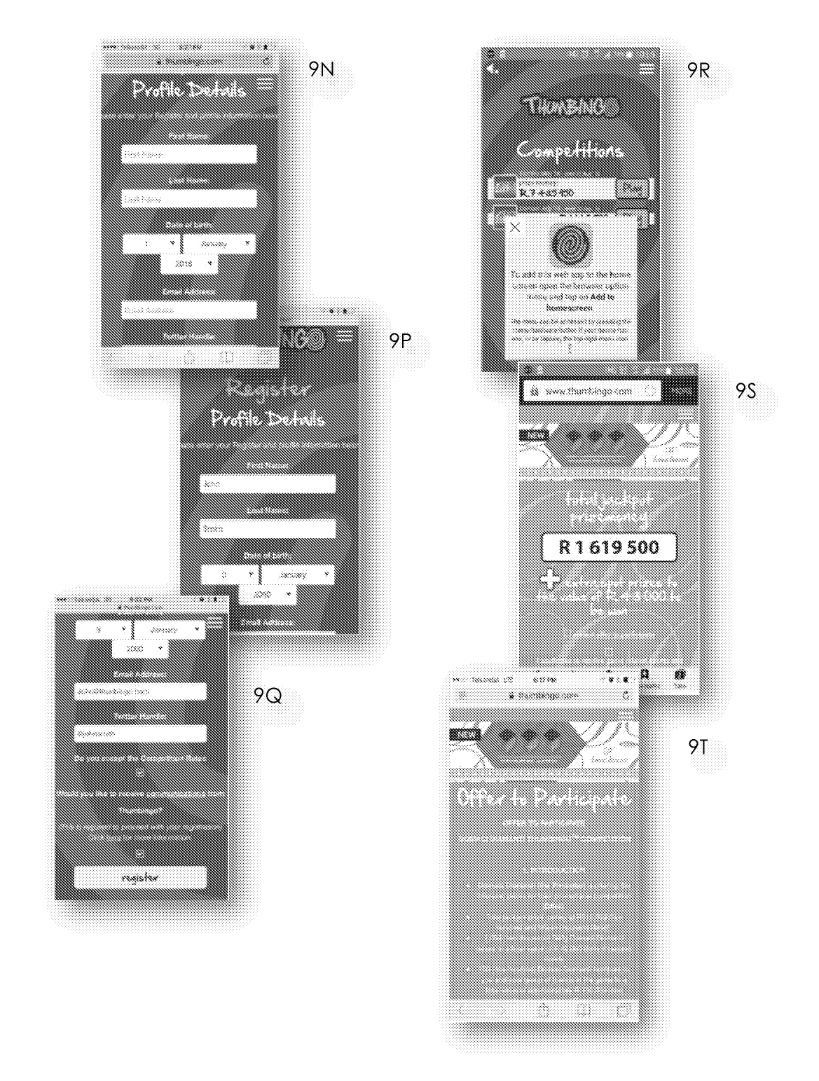

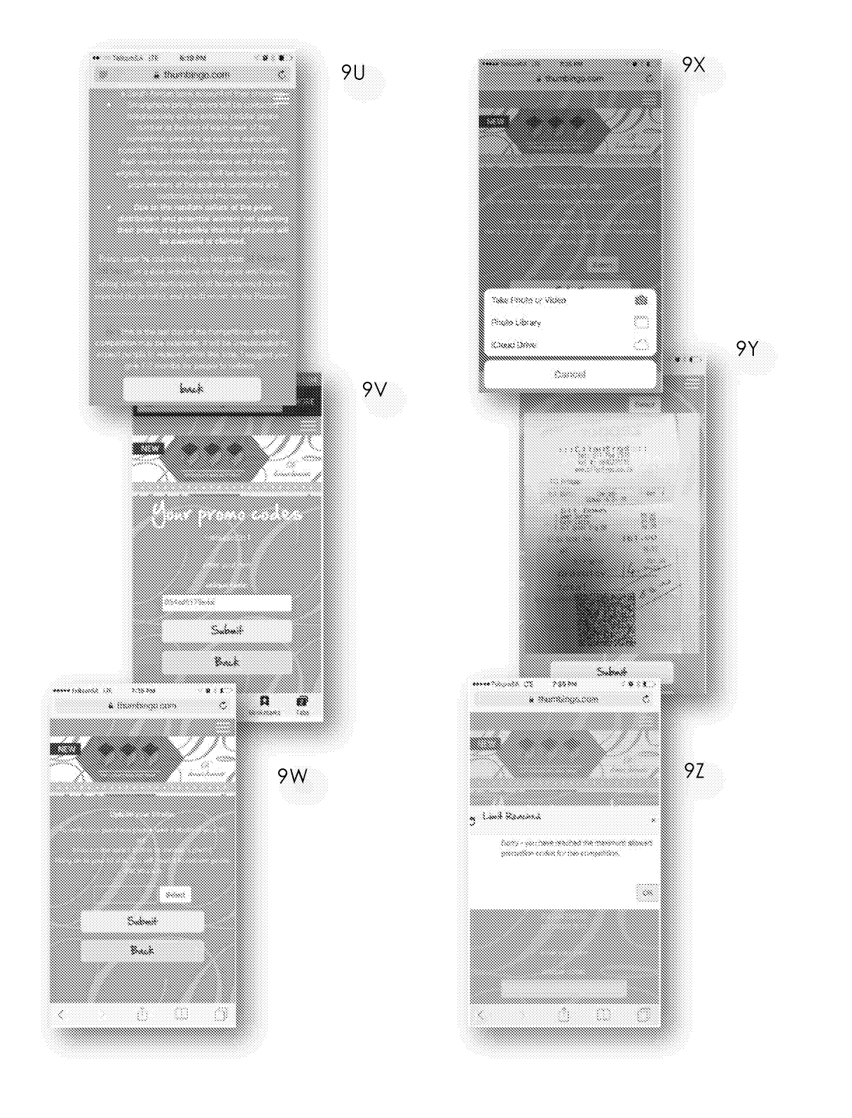

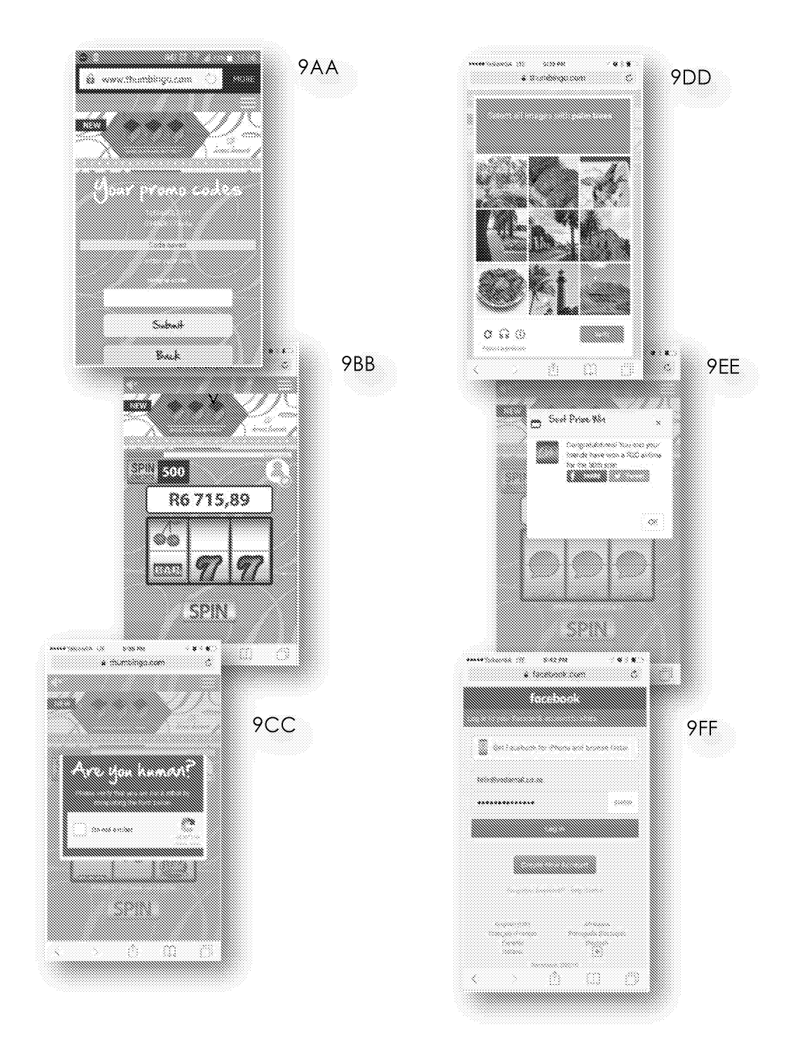

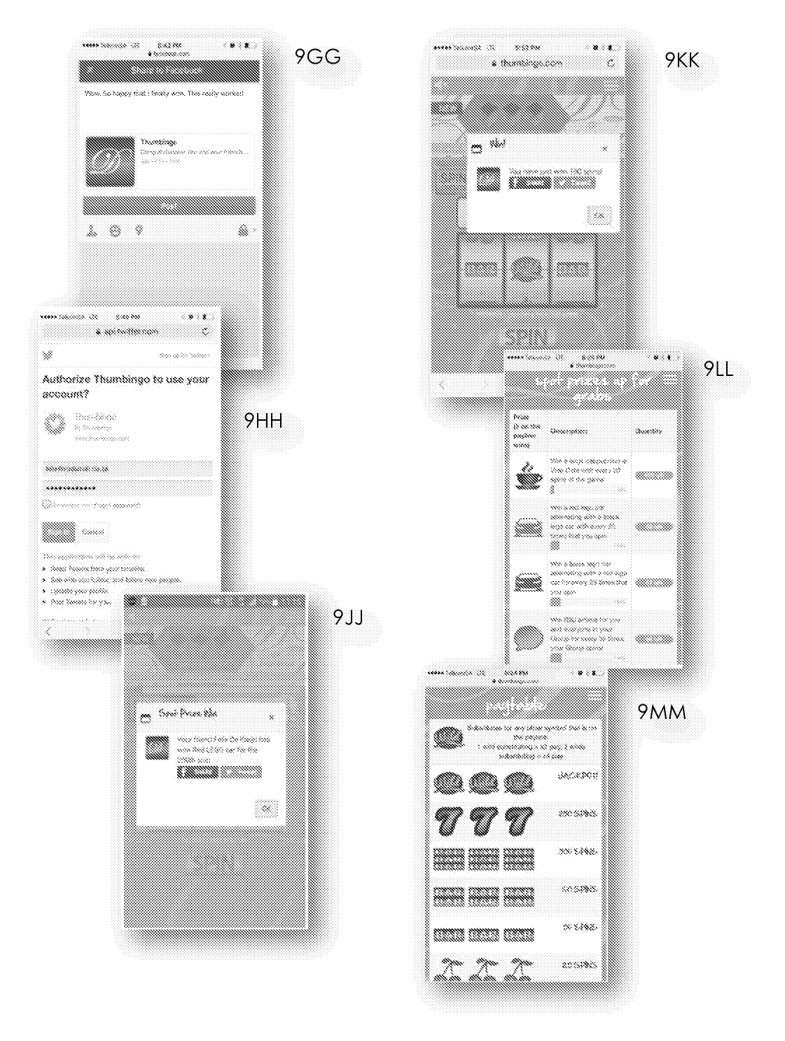

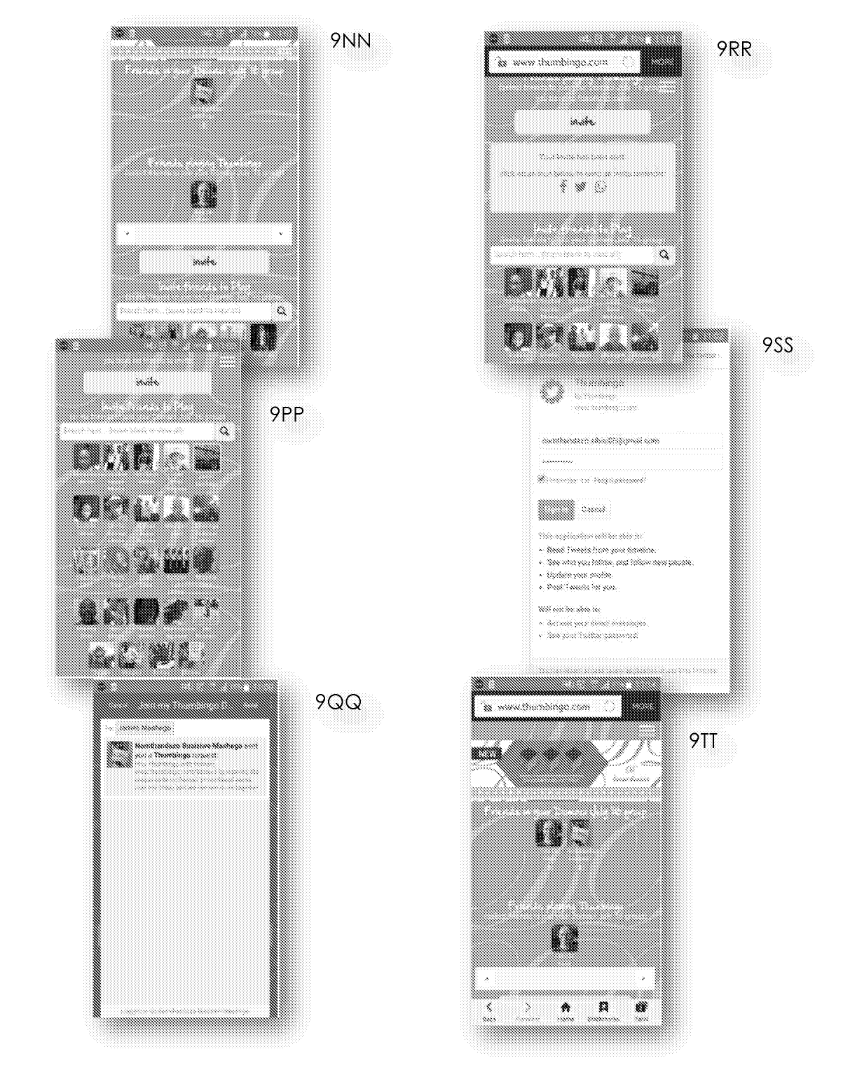

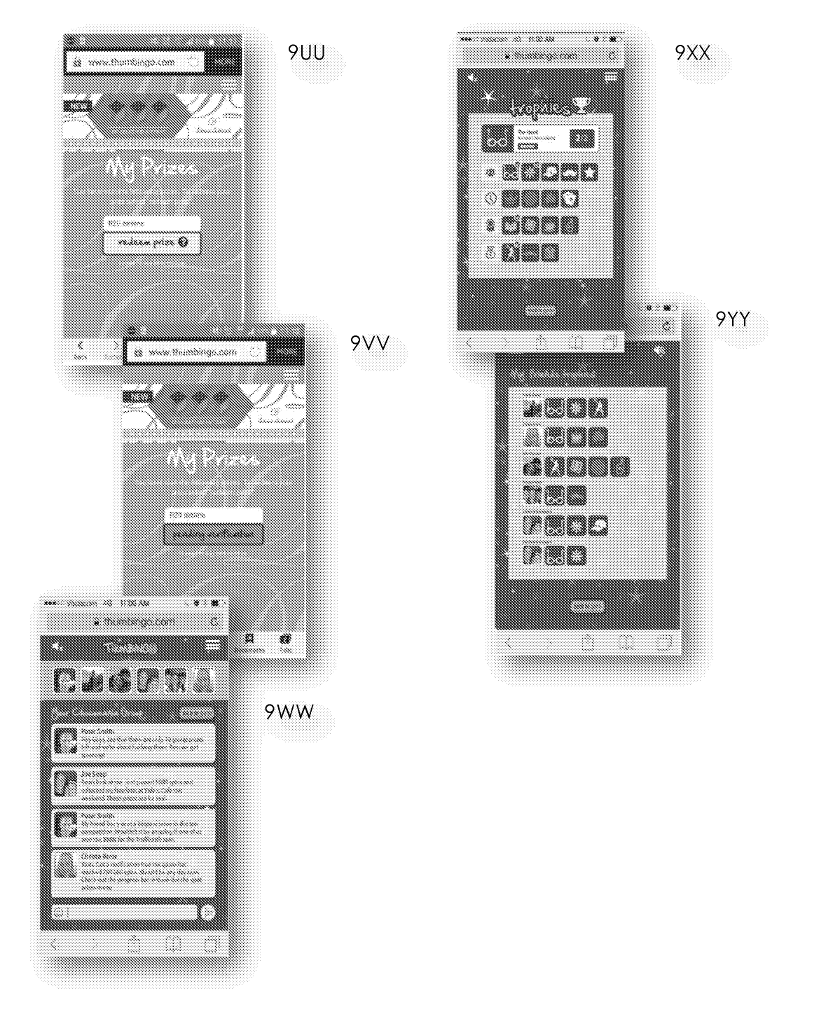

The client device application configures the client device 26 by programming the client device processor to execute the app programs. These programs direct the client device 26 to display, on a display interface of the client device 26, an application user interface 100 comprising an interactive display made up of a number of screen displays, some of which are illustrated in FIG. 9.

In addition, the app programs control communication between the client device 26 and the host server 12. To a large extent, this communication serves to guide the contestant through the various processes required to register the client device 26 on the system 10, to register for the various competitions hosted on the system 10, to participate in the various aspects of the competitions and to administer the collection of winnings or prizes and the general participation of the contestant 24 with the system 10.

In use, a contestant 24 will first download and install the app (client device application) on the contestant's client device 26.

The app, once installed, will guide the contestant 24 through a process of initialising the contestant 24 and the client device 26 on the system 10 in an initial registration process in which relatively static information pertaining to the contestant 24 and the client device 26 are recorded and stored in databases associated with the host server 12. This contestant and client device information is entered only once and saves the contestant 24 having to enter this information every time the contestant 24 wishes to participate in a competition.

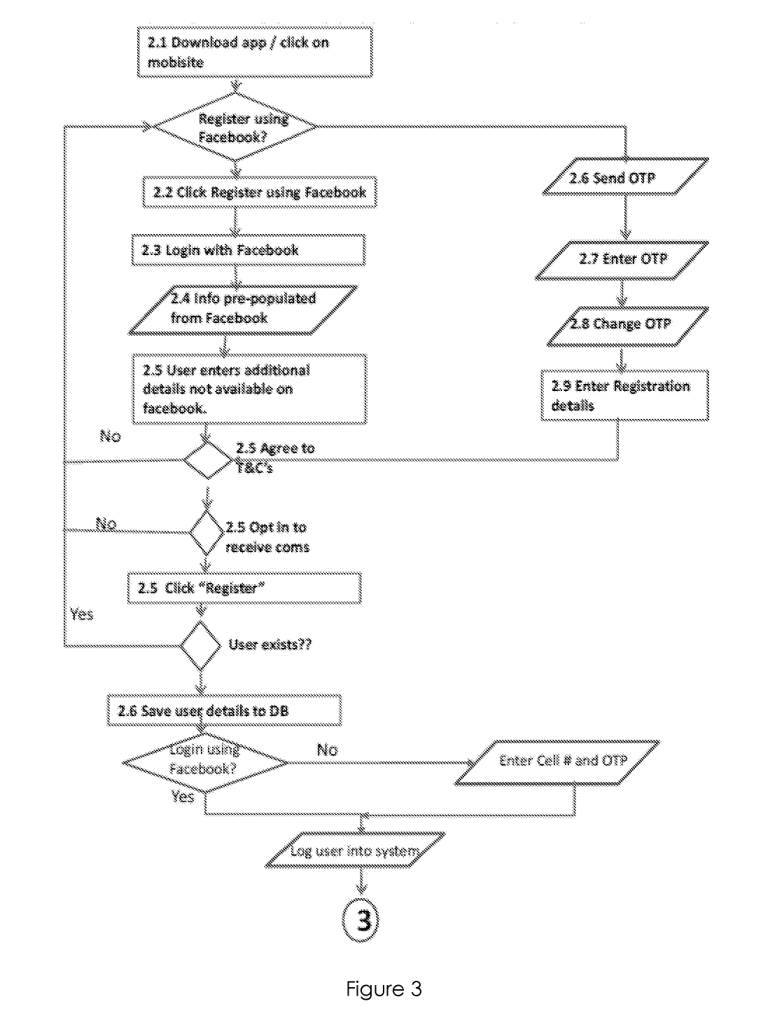

The contestant registration process is illustrated in the flowchart of FIG. 3 and the screen displays (screenshots) illustrated in FIGS. 9A to 9Q. The registration screen displays are intended to create the impression of a system operator portal or lobby in that all of the screen displays 100 are designed to display the branding and look and feel of the system operator and not necessarily any of the competition promoters 14.

The process steps are numbered in FIG. 3 and the numbered process steps relate to the FIG. 9 screenshots as follows:
2.1 relates to 9A;
2.2 relates to 9B;
2.3 relates to 9C;
2.4 relates to 9D;
2.5 relates to 9E, 9F;
2.5.1 relates to 9H;
2.5.2 relates to 9G, 9Q;
2.5.3 relates to 9Q;
2.6 relates to 9J, 9C;
2.7 relates to 9K;
2.8 relates to 9M;
2.9 relates to 9N, 9P;
2.10 relates to system processes that run in background and do not necessarily manifest on the contestant's interface.

FIG. 9A illustrates a typical first screen display which is presented to the contestant 24 when the contestant 24 first downloads the app and on every subsequent login.

On first registration, the contestant is required simply to press the “register” button, the register button, like the other buttons described in this specification, being a virtual button displayed on the screen display. On subsequent logins, the contestant 24 simply logs in using her mobile number or her Facebook profile.

In the initial registration process, the next screen displayed is illustrated in FIG. 9B which presents the contestant with options either to register with her mobile number or with her Facebook profile, the latter being preferred, since this enables the contestant 24 to play the various competitions with her friends. Registering with the contestant's Facebook profile brings up a Facebook login screen (FIG. 9C) and enables a Facebook API forming part of the client device application software to communicate with the Facebook networking system 30 to access and copy the contestant's Facebook profile, including at least the contestant's name, Facebook ID and a profile photograph of the contestant 24 (FIG. 9D). Since the contestant's Facebook profile is essentially private information, the contestant 24 is required to authorise such Facebook access and log in to Facebook.

The Facebook API is programmed to access the contestant's Facebook friends list (FIG. 9D), if the contestant 24 has a Facebook presence.

Since social networking services rarely request private information from their users and since the system 10 requires such information, a final set of registration screens (FIGS. 9E, 9F) are presented to the contestant 24 which solicits the relevant information, including date of birth, full names and email address. In addition, the FIG. 9F screen solicits the contestant's acceptance of the system's competition rules and prompts the contestant 24 to opt in to receiving communications from the system 10. These are essential communications and include alerts on new competitions; changes and updates to competition rules, terms of use and system policies; information concerning prizes and winners; and communications promoting competitions on the system 10, as explained on the opt-in screen—FIG. 9G.

The FIG. 9F screen refers to the competition rules which are made available on a series of screens, one of which is illustrated in FIG. 9H. The Terms and Conditions presented to the contestant 24 for review constitute an online, click through agreement that is digitally signed by way of the checkbox acceptance process. The standard Terms and Conditions include all terms and conditions not unique to a particular competition. This is done in an effort to avoid screen clutter and potential confusion in subsequent registration processes, when the contestant 24 will be required to register for participation in a competition which requires agreement with terms and conditions unique to that particular competition, which are referred to in what follows as “competition rules” to avoid confusion.

If the contestant chooses to register using her mobile number as opposed to registering using Facebook, then, in the background and while the registration process is running, the application server 12 In background and while the registration process is running, the application server 12 generates a One Time Password (OTP) and initiates an OTP process which prompts the contestant 24 to request and send the OTP—FIG. 9J or to request a retransmission of the OTP—FIGS. 9K, 9M. A positive response from the contestant 24 results in the OTP being sent to the contestant's mobile device 26 by way of a SMS message—FIG. 9L, which enables the contestant 24 to enter the OTP information on the OTP screen—FIGS. 9K, 9M.

By way of confirmation, the contestant 24 is then required to confirm and correct her registration details, it necessary, and also to insert her Twitter handle (name/address on Twitter)—FIGS. 9N, 9D, 9Q.

The contestant's details are recorded on the system database in the application server 12 and the contestant 24 is logged into the system 10.

As part of the background processes run by the host application server 12, the server 12 looks up the contestant's social media (specifically Facebook and Twitter) profiles and accesses the contestant's friends followers' lists. At the same time, the background process is used to determine whether any one or more of the contestant's Facebook friends also have a Twitter presence with a view to facilitating the invitation of such friends and followers to participate in the system 10 by way of various invitation mechanisms forming part of the system 10, as will be described below.

Certain social media services, such as Facebook, do not store detailed profiles of their users. In addition, a number of the services, particularly Facebook, by default, hide contest information as a means of protecting users' privacy. In contrast, other social media services, notably Twitter, allow direct posts to followers of the contestant. In the example illustrated in the drawings and using the contestant's Facebook friends list, the system 10 is able to identify the Twitter profiles of those of the Facebook friends who also have a Twitter presence and, provided they are followers of the contestant on Twitter, to send direct posts to the contestant's Facebook friends on Twitter inviting them to participate in the system 10 and in competitions hosted on the system 10 in collaboration with the contestant. In this manner, Facebook and Twitter serve as a convenient mechanism to enable the contestant 24 to invite her social networking friends to join her in collaborative play in the various competitions run on the system 10. At the same time, this mechanism serves as a convenient method of using social media networking services as recruitment tools to recruit contestants 24.

This completes the contestant and client device registration process and the contestant is now able to log into the system 10 and to select competitions to participate in or play, since the system structures competitions essentially as a playable game.

At the end of the contestant registration process (FIG. 9R), the contestant is presented with a “Competitions” screen (FIG. 9R). This screen is also accessible as a menu item on the home screen of the user interface—the menu is represented by the standard menu icon positioned in the top right-hand corner of each of the screen displays (FIG. 9).

To enter any competition, the contestant 24 must first select the competition by pressing the “Play” button on the competition selection screen and then register and eventually play the competition or game.

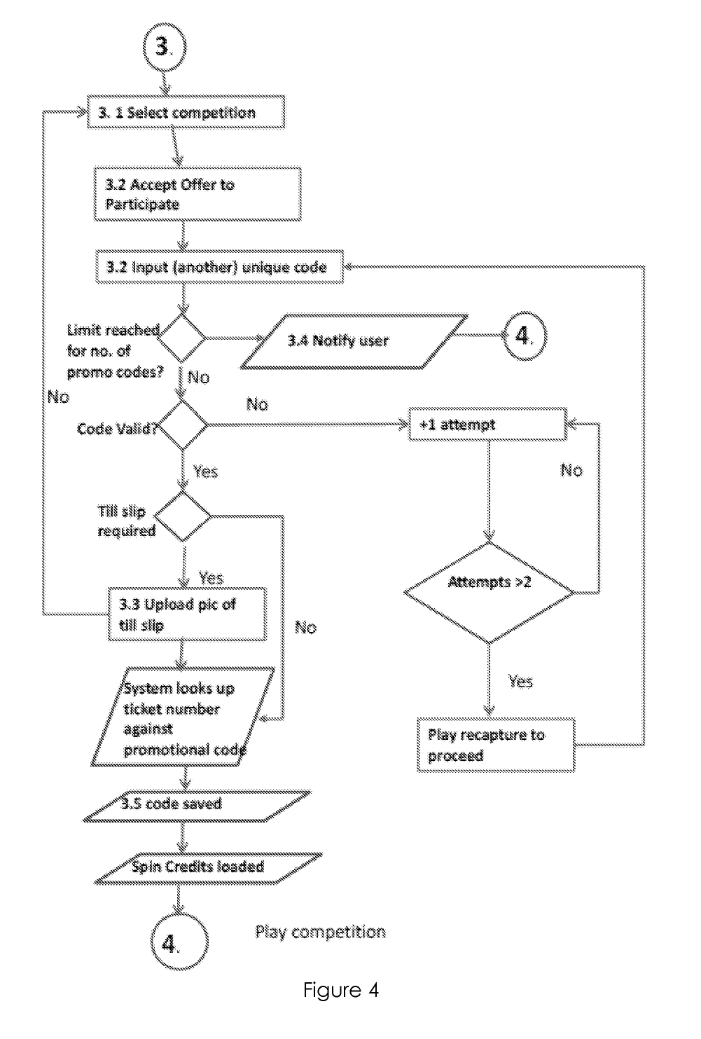

Every competition has its own dedicated registration process, standardised to some extent by the system operator. The competition registration process is illustrated in the flowchart of FIG. 4 and the screen displays (screenshots) illustrated in FIGS. 9R to 9AA.

One of the principal aims of the system 10 is to promote the products and services of the competition promoters and each promoter's competition is or can be custom-branded for that promoter and for a specific product if required, by the provision of static or dynamic on-screen branding, clickable banner advertising or the like, as the promoter might require. To this end, the competition registration screen displays are so-called white label displays—a white label display is an initially generic screen or screen template that allows a competition promoter 14 to incorporate and display the promoter's corporate branding, trade marks and trade dress, thereby to create the impression of a competition portal dedicated to the promoter 14.

The competition registration process steps are numbered in FIG. 4 and the numbered process steps relate to the FIG. 9 screenshots as follows:
3.1 relates to 9R;
3.2 relates to 9S through to 9V;
3.3 relates to 9W through to 9Y;
3.4 relates to 9Z;
3.5 relates to 9AA.

To enter the competition registration process, the contestant 24 selects a competition from the competitions displayed on the Competitions screen (FIG. 9R). This action brings up a competition information screen (FIG. 9S) with information about the competition and which invites the contestant 24 to check a box to activate an offer to participate. This action brings up a set of “Offer to Participate” screens. The Offered to participate is essentially a click through agreement that the contestant 24 must accept to proceed to participation in the competition. The contestant's acceptance brings up the next screen (FIG. 9V) that includes a code entry window, which is produced by process 3.2 (FIG. 4).

Process 3.2 allows for the input of a first promotional code and subsequent promotional codes.

In one form of the invention, the promotional code is used to derive a ticket code, which is the code used by the system 10 for purposes of enabling participation in the competitions administered by the system. To circumvent fraud, the ticket code and promotional code differ and the promotional code is simply used to derive the ticket code by means of a process of calculation carried out within the system 10.

The promotional code may be printed on the product packaging or obtained from point of purchase documentation issued to the contestant 24 at the point of purchase of the product promoted in the competition, for instance a till slip or Point Of Sale (POS) payment slip, as contemplated by process 3.3 (FIG. 4) and the screen displays of FIGS. 9W to 9Y.

The contestant 24 is required to enter the promotional code in the code entry window (FIG. 9V) and to submit the entered code to the system (FIG. 9W).

The system 10 is programmed to use the promotional code as a function in a cryptographic algorithm that produces a ticket code derived from the entered promotional code. This is done to prevent contestants 24 from guessing the ticket code in a brute force attack—a cryptographic attack in which every possible key is tried until the correct one is found. If, for example a competition promoter 14 conducts a competition using 1 million promotional codes printed on the same number of promotional packs and the ticket code is 6 digits, it would be a simple matter to guess the ticket code, since it will be any number between 000001 and 999999. To mitigate against a brute force attack, the system 10 is programmed randomly to assign another number between 000001 and 999999 to a valid promotional code to generate the ticket code.

Once a ticket code has been assigned it cannot be used again for the purpose of generating the next ticket code as each ticket code needs to be unique.

The ticket code could be all numbers or all letters or any combination of numbers and letters or even symbols, ranging from a 4-part ticket code for a very small competition to an 8-part code for a substantially larger competition. The length of the ticket code is customisable in the administrative interface of the game server 16. Competition promoters 14 will select the length of the ticket code with a view to paying out all of the available prize money during the course of the competition, but also to create odds where contestants 24 are reasonably likely to win the jackpot prize.

Once the contestant 24 inputs the promotional code, the system 10 will conduct a lookup to confirm that the promotional code is valid and if it is, the ticket code is derived algorithmically and saved as a playing credit in respect of that contestant 24. The code is added to the contestant's list of codes and displayed on the contestant's user interface (screen display, FIG. 9AA—in which the codes are referred to as “promo codes” even though the codes are in fact ticket codes). The contestant 24 is not required to enter any other information at this point, static contestant and client device information having been entered previously.

The same process is followed when the contestant 24 runs out of playing credits, the contestant 24 being able to acquire additional promotional codes, for instance by purchasing more of the promoted product and to enter the additional promotional codes in the process 3.2.

There are a variety of mechanisms by means of which competition promoters 14 can communicate promotional codes to prospective contestants 24. In the example illustrated above, the promotional code is obtained from point of purchase documentation issued to the contestant 24 at the point of purchase of the product promoted in the competition. Alternative examples include printed promotional codes on specially marked promotional packs, scratch cards given as a reward to customers on purchase of a service, such as servicing a vehicle at a vehicle dealership or bar codes, or QR codes or other images that need to be scanned and transmitted to the competition promoter 14, to name but a few examples.

In each case, it is preferred that the promotional code be separately supplied, either by deriving the promotional code from a source external to the system 10 and the competition, as in the examples cited immediately above, or by supplying the promotional code by way of a separate communication, such as an advertising communication sent to the client device 26 in a communication stream (such as a SMS or a USSD session) unrelated and external to the competition. For instance, the prospective contestant could be encouraged to purchase a product and the point of sale merchandising display could contain a message urging the contestant to SMS a till slip code to a number displayed on the merchandising display. The system 10 will then return a promotional code to the contestant's mobile phone.

To be effective in driving product sales and awareness of the product being promoted by the competition, it is important that the promotional code be derived externally of the online system 10 and preferably from activities associated with purchasing of the promoted product or service.

Contestants 24 are encouraged to enter as many promotional codes as they like and hence purchase more promotional product, each code being added to the contestant's code list. In certain competitions, however, it may be appropriate to limit the number of promotional codes a particular contestant is allowed to enter into the system 10.

The system 10 may conveniently include a verification process for promotional codes. To implement the verification process, a promoter 14, when setting up a promotional campaign and competition in the administrative interface of the game server 16, may be given the option to enable image capture functionality which enables the contestant 24 to capture an image of a point of sales document, such as a till slip using her mobile device 26 to capture an image (take a photo) of the point of sales document, immediately after entering the promotional code (process 3.3; FIGS. 9W to 9Y). Failure to capture an image will mean that the contestant 24 cannot proceed into the competition.

At this point no actual verification of the sales document is undertaken. The system 10 merely stores the image against the contestant 24 on a database. Such verification will only take place when a contestant wins a prize.

The system 10 may be configured to allow a promoter 14 to include, on the rules screen (FIGS. 9T, 9U), an opt-in checkbox to receive further marketing communications from the Promoter.

The system 10 is configured to prevent the use of internet bots to participate in the competitions—an internet bot or web robot is a software application that runs tasks automatically over the Internet. To prevent the use of internet bots, the system requires contestants 24 to confirm that they are human by way of occasional CAPTCHA tests (CAPTCHA is an acronym for Completely Automated Public Turing test to tell Computers and Humans Apart—a type of challenge-response test used in computing to determine whether or not the user is human). The system 10 is configured to run a CAPTCHA test if a contestant 24 fails to enter a valid promotional code in more than two attempts or after a predetermined number of plays—50 or 100 should provide a good balance between the inconvenience to the contestant 24 and the need to protect the competition from bots.

The promotional code generation mechanisms referred to above all require a substantial amount of effort on the part of contestants 24, for instance by verifying the promotional code, retaining till slips or taking and saving screenshots of till slips. To get around these requirements, the system 10 could more conveniently be configured to generate promotional codes using a data encryption algorithm (preferably 3DES) to encrypt and decrypt the promotional codes using a pre-defined string as a key. To enhance security, the system 10 may conveniently be configured to insert check blocks of data in the promotional codes, the check blocks being constituted by characters inserted in the encrypted promotional code at known positions. The system is configured to check the check blocks first, remove them from the promotional code string and then decrypt the code to get a valid ticket code. If the check blocks fail or the string does not decrypt once the check blocks have been removed, the code entered is invalid.

Besides doing away with the contestant 24 having to take a screenshot of the till slip or hold onto the till slip, this promotional code generation mechanism requires no communication between the POS system generating the promotional code at the point of sale, since no communication is required with a database that holds the codes as in other implementations of the code generation mechanism, thereby making issuing of the codes quick and easy.

Using the playing credits (promo codes) in her code list the contestant 24 is now in a position to participate in the competition or “play” the competition as indicated in the last process step in FIG. 4.

FIG. 9BB illustrates the preferred spin screen on which contestants 24 actually play the competition. In this configuration of the system, a contestant 24 executes a play on the system by pressing a “spin” button on the contestant's system client device display. In different configurations of the system and competition is presented on the system, execution of plays will be determined by the configuration of the interface in each case.

The system of the invention lends itself to the administration and implementation of a number of different types of promotional competitions, such as lucky draw competitions.

However, the preferred implementation of the system of the invention is to configure the competition playing interface to resemble a familiar three-reel slot machine or interface (FIG. 9 BB) that displays a jackpot amount in a jackpot window and three virtual spinning reels in a reels window, each virtual reel being programmed to display a predetermined number of symbols, the number and appearance of which are determined by a typical slots pay table (see FIG. 9MM). The interface includes a “Spin” button that, when pressed, causes the reels in the reels window to display the symbols in rapid sequence, thereby creating the appearance of a virtual spinning motion. When the “spinning reels” come to “rest”, that is when the virtual spinning motion stops, the reels each display a symbol in the reels window.

In this implementation of the competition playing interface, the principal prize is a jackpot preferably a progressive jackpot, the amount or nature of which is determined by the competition rules. In conventional gambling games involving bets or wagers with progressive jackpots, a percentage of each bet or wager is allocated to a jackpot pool. In the case of the system of the invention, however, there are no bets or wagers to grow the jackpot. Instead, the jackpot is determined by the competition promoter 14, with the system 10 being configured to provide fixed and variable jackpot components. The fixed jackpot increments evenly over the duration of the competition, with the system 10 allowing the promoter 14 to optimize the jackpot implementation so that the jackpot does not run out before the competition expires.

The variable jackpot is implemented in the system 10 as a scheme of jackpot “boosters” which are linked to actions which fulfil the marketing objectives of the competition, for instance entering additional promotional codes or clicking on a product advertisement or inviting social media friends to play the competition. The size of the jackpot is determined by the promoter's competition budget and is defined, by the promoter 14, at the onset of the competition. It is related only indirectly (through the boosters) to spins of the game interface reels.

As indicated above, the contestant's valid ticket codes are saved as playing credits in respect of that contestant 24 that, upon validation, are displayed on the screen display of FIG. 9AA, where they are referred to as “promo codes”. as the contestant's promo codes on the screen display of FIG. 9AA. These playing credits are translated into spin credits in accordance with the rules of the particular competition and display as spin credits on the main slots game playing interface (FIG. 9 BB). With each press of the spin button, the spin credits are decremented in accordance with the rules of the particular competition and when the spin credits are exhausted, the contestant 24 can only continue playing the competition by acquiring additional spin credits.

To acquire additional spin credits, the contestant 24 must either enter additional promotional codes, as described above with reference to FIG. 4 or certain competitions might award spin credits (almost as winnings) upon the achievement of certain competition goals. Alternatively spin credits can be “won” when the result of the spin on the pay line matches a winning combination on the pay table. Since the system 10 is constructed around collaborative playing of promotional competitions, one of the principal means of acquiring additional spin credits should be the promotion of collaboration in playing a competition, by the contestant 24 inviting her social media friends to play the competition collaboratively with her. This will be determined to large extent by the rules competition promoters 14 introduce into their competitions, but it is believed competition promoters 14 will soon realise the benefits to their promotions of collaborative competition play and actively encourage collaborative competition play by awarding spin credits generously as a means of rewarding collaborative play.

As indicated above, the system 10 is configured to run a CAPTCHA test if a contestant 24 fails to enter a valid promotional code in more than two attempts or after a predetermined number of plays. Being a promotional competition system, however, the system 10 preferably makes use of a CAPTCHA game instead of a simple CAPTCHA test. One such game is playCAPTCHA™, an interactive, advertising-based mini game supplied by Future Ad Labs, UK. The playCAPTCHA™ system, when activated by the system 10, displays a query screen (FIG. 9CC) that requires the contestant 24 to play a mini game incorporating an advertised product by selecting a picture displayed on the following screen (FIG. 9 DD), which could be a picture of the product being promoted located within a random selection of non-promoted products. A successful outcome of the mini game determines automatically that the contestant is not a robot, at the same time capturing the contestant's attention on the product promoted in the promotional competition.

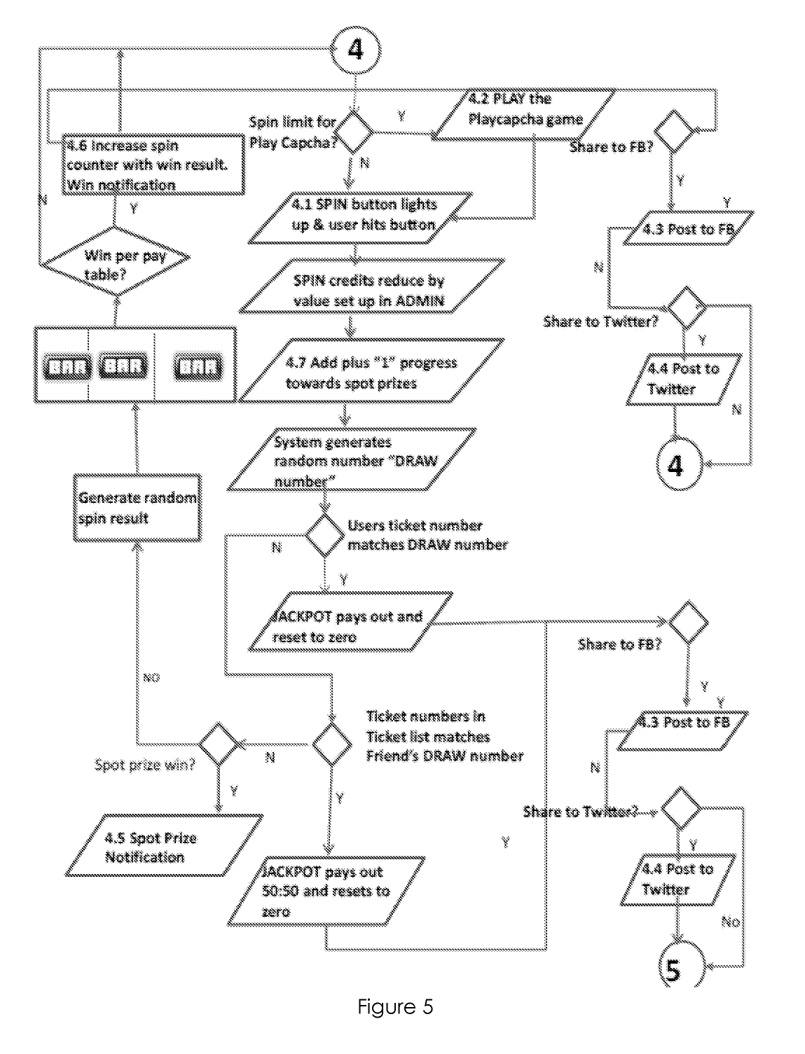

Process 4.7 in FIG. 5 illustrates the manner in which the system 10 allows the contestant 24 to progress towards a prize (in this case a spot prize) each time the spin button is pressed.

In addition, each press of the spin button generates a random “draw” code. If the draw code matches any of the contestant's ticket codes, the spinning reels come to rest in a manner that displays lined up jackpot symbols in the reels window, to indicate that the contestant has won the jackpot. In such an event, the jackpot pays out and resets. In the preferred form of the invention, the jackpot resets to a predetermined minimum instead of to her as indicated in FIG. 5.

If the draw code does not match any of the contestant's ticket codes, the system 10 could still award a spot prize (FIG. 9EE), depending on the rules of the particular competition. Spot prizes could be a payout or a redeemable token for products of the promoter 14. Instead or in addition, spot prizes could go toward stopping up the contestant's spin counter, in effect awarding additional playing credits.

The system is configured to broadcast notifications of all winnings, preferably by posting notifications to social media sites, such as Facebook and Twitter—FIGS. 9FF to 9KK.

To incentivise contestants 24 to keep on playing, the system 10 is also configured to post notifications in-system and on social media sites of prizes that can still be won within the competition—see for example the notification screen illustrated in FIG. 9LL.

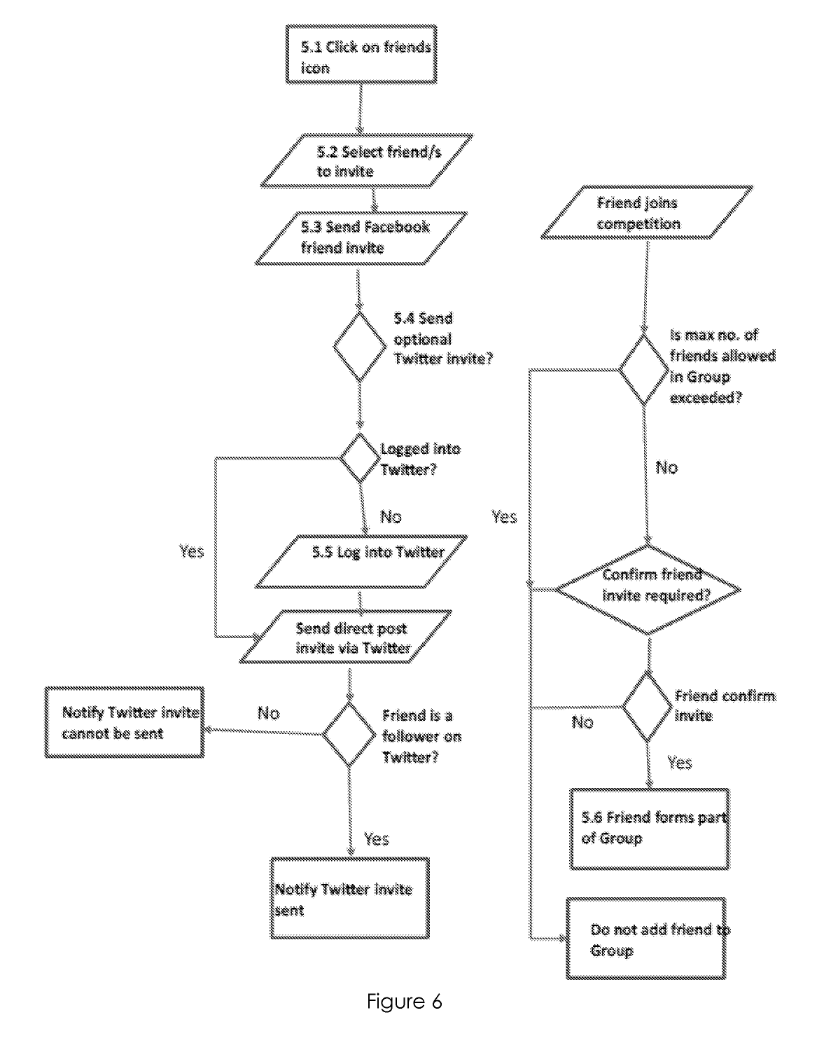

In the preferred form of the invention, the system 10 is centered around the creation and administration of competition-playing groups. To this end, the system 10 is configured to direct contestants 24 to invite their social media friends into the competition. The social media friend invitation process is illustrated in the flowchart of FIG. 6 and the screen displays (screenshots) illustrated in FIGS. 9NN to 9TT in which the numbered process steps of FIG. 6 relate to the FIG. 9 screenshots as follows:
5.1 relates to 9NN;
5.2 relates to 9PP;
5.3 relates to 9QQ;
5.4 relates to 9RR;
5.5 relates to 9SS;
5.6 relates to 19TT.

These screens enable the contestant 24 to invite their social media friends into the system, thereby to enable these social media friends to join the contestant 24 in playing competitions collaboratively.

To this end, the system 10 positions a friends icon on the spin screen (FIG. 9 BB) that brings up a friends screen (FIG. 9 NN) when pressed. The friends screen is also accessible by way of a drop-down menu.

The system 10 recognises three levels of friends: friends on social media not yet on the system 10 (FIG. 9NN); friends registered on the system 10, but not yet collaborating in a particular competition (FIG. 9PP); and friends registered on the system 10 and collaborating in a particular competition (FIG. 9TT).

At the time of contestant registration (and after that if necessary), the system 10 scans the contestant's social media profiles as described above to search for social media friends of the contestant 24 and saves relevant contact information of such social media friends on the system 10 to enable the contestant 24 to search for her social media friends by way of the friends screen (FIG. 9NN). Once displayed on the friends screen, the contestant 24 can select one or more of her social media friends and then click an “invite” button to invite the selected social media friends to join the system 10, with a view to these friends joining the contestant 24 in a particular competition. As an incentive, the system 10 is preferably programmed to award a bonus (such as a spot prize or spin credits) for inviting social media friends into the competition.

To facilitate the friends introduction process, the system is programmed to allow the contestant 24, with a few simple clicks, to message such unlisted friends with an invitation to join the system. To do this, the contestant 24 sends a friend request with a pre-populated message by way of the in-system messaging service of the particular social networking service 30 to friends the contestant 24 wishes to invite. The system 10 is programmed to create a link in the system database between the inviting contestant 24 and the invited friend, after which there is no further requirement for communication by way of the social networking service 30 or any messaging service forming part of the social networking service 30.

The system is preferably also programmed to remind invited friends by way of Twitter. The system 10 is programmed to search for people following the invited friend on Twitter and to post a Twitter message directly to the invited friend. The benefit is that Twitter sends an email to the invited friend in addition to the message.

On receipt of the friend request from the contestant 24, the invited friend can either reject the friend request or accept it in which case the invited friend will be required to register as a contestant on the system 10. The invited friend will then be able to accept or reject the invitation to join the group. Once the friend has joined the group, their profile photo from the social networking service 30 will appear on the group screen of all the contestants 24 in the group.

The system 10 preferably includes means to indicate whether a contestant 24 is online within the system. The simplest indicator is a dot located next to the contestant's profile picture Facebook with a green dot, for instance, indicating that the contestant 24 is online and a red dot, for instance, indicating that the contestant 24 is off-line.

Once a social media friend of a contestant 24 has joined the system 10, that social media friend is available to invite into a competition. When the friend accepts the invitation, the friend joins the contestant 24 who, with her friend or friends in the competition form a competition group which can play the competition collaboratively.

The system makes it possible for competition promoters 14 to limit the number of friends allowed in a competition group.

The benefit of inviting social media friends to join the contestant in a competition group is that prizes and awards within the competition are shared in a number of ways between contestants in the group.

For instance, the contestants 24 in the group all spin the reels at different times during the course of them playing the competition. On each spin, the system 10 produces a draw code and if a contestant's ticket code matches the draw code, the contestant is awarded a prize.

With multiple contestants in a competition group, if the draw code of one of the contestants 24 matches the ticket code of one of the other contestants (a friend) in the group and a prize is awarded, the contestant and the friend will then share in the prize in accordance with the rules of the competition.

For example, if a contestant 24 wins the jackpot (the contestant's ticket code matches the draw code produced by the system 10), the contestant wins a jackpot for instance and if the contestant's ticket code matches the draw code of a social media friend of the contestant (who joined the game as a result of the contestant's invitation), the jackpot is shared between the contestant and the social media friend.

One of the ways of incentivising contestants to introduce social media friends into the system and into competitions is to award spin credits for friends introductions.

In-game and social media notifications are sent to everyone in the contestant's group when someone in the group wins any prize.

The social media groups mechanism can be applied to a number of other games and competitions to introduce a social element where social media friends work together to achieve a common goal.

For instance, in a digital variation of the well-known Monopoly™ board game, competition entrants collect digital place cards—the digital equivalent of the cards denoting addresses printed on the digital equivalent of the Monopoly board, where addresses are arranged in sets. The digital game allows individual contestants to collect place cards with the aim of accumulating a set of cards, which entitles the contestant to win a prize. As with the board game, there are common cards and rare cards.

Using the group mechanism of the invention to such collection or pursuit games, the individual pursuit of tokens (place cards in the digital Monopoly example) can be supplemented by a group pursuit where social media friends work together in groups to collect a set of cards and win the relevant prize. Depending on the rules, the prize is then shared by the members of the group according to a formula predetermined in the rules. Using the example of a rare card in the digital Monopoly example, if the prize for collection of a set of cards including a rare card is R1 million, the group members might, between them, already have all the common cards in a set, with only the rare card being missing. If one of the group members then collects the rare card, the group combines their cards to complete the set and collect the winnings, with the group member electing the rare card, for instance, taking the bulk of the winnings and the remainder of the winnings being shared between the remaining group members.

The group mechanism also lends itself to goal-driven rewards programmes, for instance programmes that reward participants who participate in the promotional and marketing activities of the promoter or who achieve specified goals.

Fitness goals are often used by medical schemes to reward medical scheme participants. Using the group mechanism of this invention, the system can be used to introduce peer pressure into the process of monitoring goal achievement. The system 10 can also be used to distribute points and rewards within such goal-driven rewards programmes.

Goal driven rewards programmes need not have meaningful goals and a number of games and programmes are known where the goal is simply repetitive behavior. At the one end of the scale, the repetitive behavior could be meaningful, such as the number of steps recorded on a pedometer—a type of fitness goal. At the other end of the scale, the repetitive behavior could be relatively inane, such as tapping a coin on a virtual button on a smart phone screen. The group mechanism of this invention can be used to introduce group participation in these behaviors, to monitor goal achievement and to distribute points and rewards within these programmes.

Companies in the fast-moving consumer goods market often conduct loyalty programmes in which consumers are invited to participate. Participants earn points by finding promotional codes on products of the programme promoter, which points are “banked” and subsequently redeemed in exchange for physical goods or other rewards, such as digital gift cards. Points can also be donated to worthy causes, such as a charity organisation or a local school. Using the group mechanism of this invention, the system 10 can be used to sign up participants in a loyalty programme and to distribute points within such a programme, with the added benefit of using the group mechanism quickly and easily to organise social media friends into groups and to pool their points for rewards.

As a side benefit, contestants 24 in groups formed on the system 10 could combine their endeavors in respect of causes other than participating in a promotional or other competition. So for example, contestants 24 can use their group relationship to contribute towards buying a shared gift for a special occasion, for example where the gift is a big ticket item like a car.

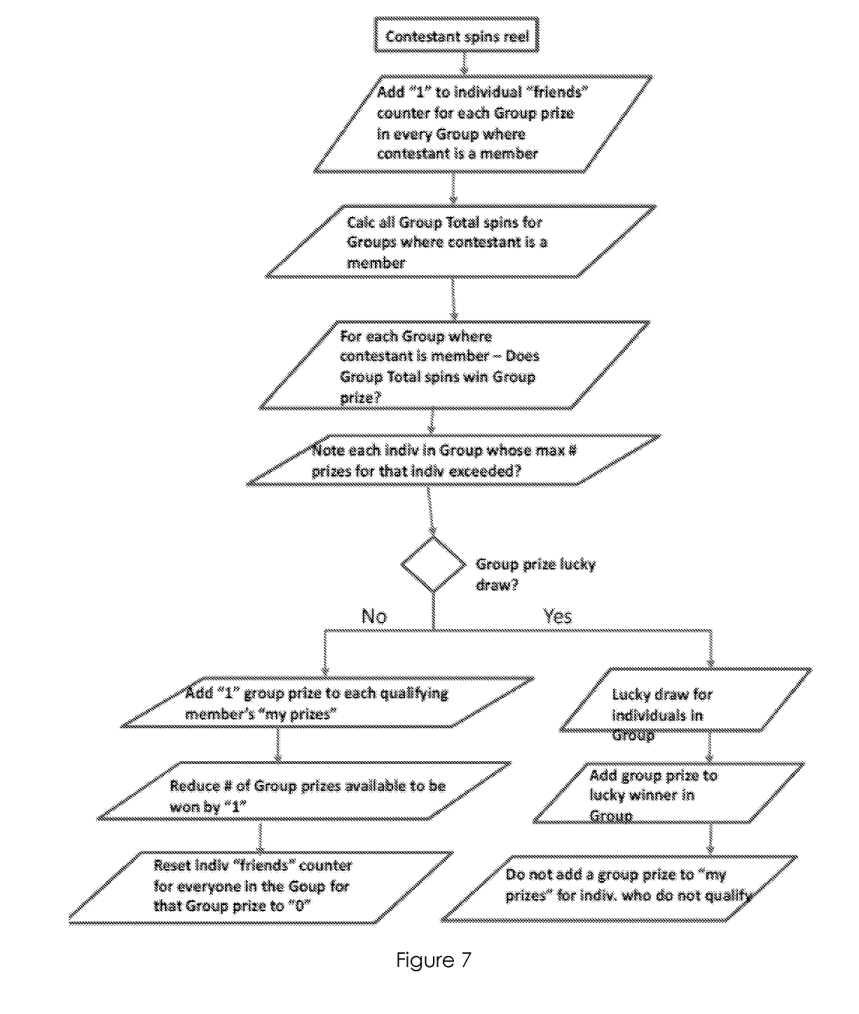

To facilitate the administration of competition-playing groups, the system 10 makes use of a scheme of counters which is illustrated in the flowchart of FIG. 7. The system differentiates between individual counters, friends counters, group counters and competition totals counters.

Each contestant in a competition has an individual counter that tracks the spins of that individual contestant 24 in that particular competition, regardless of group affiliation.

Friends and group counters are specific to groups in a competition.

A contestant 24 may participate in a particular competition in collaboration with more than one group and the contestant's spins in the or each group contribute towards the total spins of that group. In each group, the contestant's friends counter tracks the spins she contributes towards that group. The contestants' friends counter registers are reset to zero from time to time in accordance with the rules of the particular competition, for instance when a prize is awarded within the group.

The group counter value is unique to a group in a competition. The group counter value is derived by adding up (summing) the friends counters of all the contestants in a group and provides a record of the total number of spins by all the contestants in a particular group in a particular competition.

To enable the awarding of a plurality of group prizes during the course of a competition, the group counter values are stored in a plurality of group counter registers, so that each group prize can have a separate group counter attached to it. So for example, if there are two group prizes in a competition, one being “win a pizza for you and everyone in your group for every 20,000 group spins” (Prize A) and the other being “win a holiday for you and everyone in your group for every 100,000 group spins” (Prize B), each member in the group will have separate Prize A and Prize B friends counters. When the group wins Prize A, the Prize A friends counter of every member in that group resets to zero, but the friends counter for Prize B is unaffected. The Prize B counter continues to increment until Prize B is won, in which event the Prize B friends counter for every member in that group resets to zero. However, the friends counter for Prize A, which may have reset and started re-incrementing in the interim, is unaffected and continues to increment until Prize A is won. This cycle can continue, depending on the rules of the particular competition.

The competition totals counter is unique to a competition and is derived by adding up (summing) the friends counters of all the contestants in a competition and provides a record of the total number of spins by all the contestants in a particular competition. To enable the awarding of a plurality of prizes based on spin totals achieved during the course of a competition, the competition totals counter could track and report on milestone spin totals predetermined in the competition rules. Alternatively, the competition totals counter values could be stored in a plurality of competition totals counter registers, which operates similarly to the group counter system described immediately above.

As illustrated in FIG. 7, if the group wins a group prize, the system first determines if any individual in the group has exceeded the maximum number of prizes for that competition, since the competition rules might determine that such an individual will not qualify for a prize. The system then awards prizes to qualifying group members, but not to members who do not qualify. The system then resets the friends counter registers for that group to zero. Subsequent spins by members of the group playing the competition increment the friends counters that make up the group counter of that group once again.

The player user interface is configured to display individual contestants' individual counters with a view to creating peer pressure as a result of friends in a group seeing which members of the group contribute more or less than others.

Using the system 10, a competition promoter 14 is able to award group prizes, which are prizes awarded to each individual in the group, depending on a specific achievement by that group. The system 10 is configured to allow a competition promoter or administrator 14 to limit the number of group prizes available to be won, by allowing the rules of the competitions to include such limitations, particularly for situations in which group prizes are products that are given away to each member of the group. This is to limit competition promoter exposure to unlimited giveaways.

By the same token, the system 10 is configured to allow a competition promoter 14 to limit the number of group prizes that any one individual contestant can win. In the preferred form of the invention, an individual who has won the maximum number of prizes can still contribute towards the group total spins for the groups in which he is a member.

The competition administrator 14 is also able to determine the number of friends in a group, once again based on the rules for that competition.

After each prize is won the counter that tracks the remaining number of prizes available reduces by one. With each group prize win, the group prize counter only reduces by 1 regardless of how many friends there are in the group that wins the prize.

The system 10 checks to see whether a contestant has won an individual prize or a group prize after each spin that an individual contestant makes. For the individual prize the system first checks to see if there are any remaining prizes. If there are prizes left to be won, the system then checks to see if the individual counter matches the number of spins required for that prize e.g. if the prize is to win a spot prize for every 1000 times that the contestant 24 spins and the contestant has just spun his 5000th spin, then the system will award that contestant an individual prize.

Immediately upon the award of a group prize, the system 10 is programmed to reset the friends counter of every member of the group to zero and to start incrementing the friends counters again. This is to ensure that the group prize wins are not duplicated by the system 10.

When a contestant 24 wins a prize, her individual counter does not reset to zero. The individual counter therefore acts as a record of the total number of spins by a contestant 24 in a particular competition.

The system enables the competition administrator 14 to limit the number of group prizes that any individual contestant can win. For example, if the number of group prizes that an individual can win is set to “1” and that contestant has already won a group prize from one of the groups where she is a member, the contestant's spins still contribute to the other groups but when one of those groups wins, that contestant does not share in the prize, since the contestant has already won. This will prevent situations where members of very large groups win multiple times notwithstanding that their spin total contribution towards the group totals is negligible.

When a contestant 24 joins a group, her individual counter is not added to the group or competition totals counters of that group. Her contribution to the group and competition totals counters of that group starts at zero, otherwise a situation might arise where contestants 24 who have accumulated large spin totals cause a group to instantly win the moment they become a member of the group.

Between the built-in system functionality and administrative tools made available to competition administrators 14, there are a number of ways to ensure that the system 10 distributes group prizes as widely as possible and that winnings are spaced as evenly as possible over the lifespan of the competition. In summary, these are the following. The administrator 14 is able to limit the number of individuals in a group; the amount of group prizes that an individual can win in a competition; and the number of group prizes available to be won. In addition, the system is configured to ensure that: each time a contestant joins a group, the joining contestant's contribution to the group counters unique to that group is started, in each case at zero, regardless of the balance of the contestant's friends counter in other groups previously joined by the contestant; when a particular group wins a prize, the friends counter of every member of that group resets to zero; and groups exist only within competitions—when a contestant 24 joins another competition, the contestant 24 must start inviting and building groups from scratch within the new competition.

Some competition promoters wish to award large prizes, which can present difficulties in certain circumstances, particularly when it comes to awarding group prizes. For example, a competition promoter might wish to offer 10 overseas holidays, each worth a substantial amount of money. The goals for each holiday might then be set at 100,000 group spins and the maximum members allowed in a group might be limited to 100 members, having regard to the relatively high spin target.

To award such a prize, the system 10 is configured to allow the awarding of an exclusive lucky draw that takes place only amongst the members of a group that achieves the spin target. The result is that only one group prize is awarded for every group that hits the target, up to the available number of prizes.

Prizes based on lucky number draws make use of the competition totals counter. For example, “win a motorcar for the lucky one millionth” spin of the game.

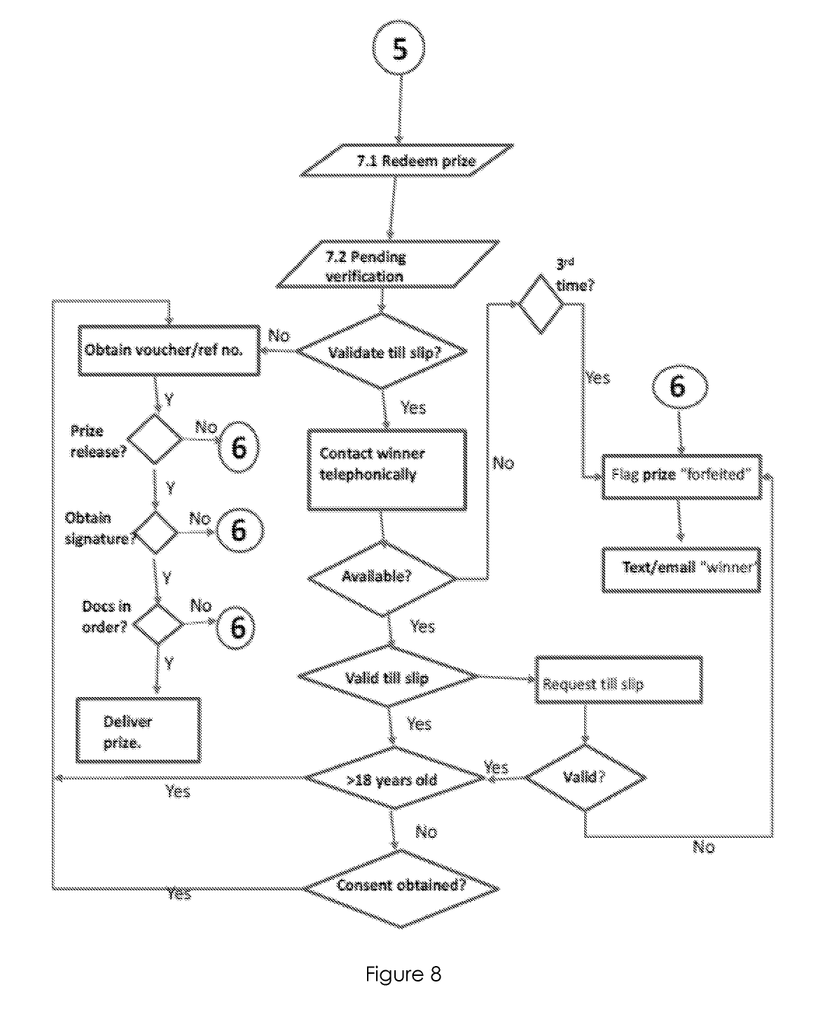

Prizes, winnings, and the administration of prizes and awards is illustrated in the flowchart of FIG. 8 and the screen displays (screenshots) illustrated in FIGS. 9UU and 9VV in which the numbered process steps of FIG. 8 relate to the FIG. 9 screenshots as follows:
7.1 relates to 9UU;
7.2 relates to 9VV.

In the competition, the ticket code (that matches a prize draw code) is the subject of an audit to ensure that it is valid, for instance that the contestant 24 did in fact purchase a qualifying product.

When a contestant wins a prize, she will be presented with a prizes screen (FIG. 9UU) that enables her to press to select and redeem a prize.

In circumstances where a competition promoter 14 has introduced a prize-winning verification process, as outlined above, any win will first be subjected to a verification process. The system 10 then brings up a notification screen (FIG. 9VV) to advise the contestant that her prize win is pending verification before she is able to redeem her prize by displaying a message to the effect that the win must first be verified, e.g. “pending verification”.

As an example, where a payment or till slip was used to provide the contestant's promotional code, the audit facility will attempt to validate the till slip. Entry screens are used to guide the contestant 24 through a process of scanning or photographing the till slip containing the relevant promotional code and submitting the images to the system operator for verification. The verification process could be a manual process undertaken by the support staff of the system operator. In the verification process, the support staff will check that the number of ticket codes correspond to the number of products purchased, by visual inspection of the images of the relevant sales documents. Where the detail cannot be made out from the sales documents, for instance if the image is blurred or cut off, then the support staff may contact the winner and ask for the sales documents to be produced.

Any failure of the verification process will, in most circumstances, result in the allegedly winning contestant forfeiting the prize. The conditions pertaining to the verification process will be contained in the competition rules and the offer to participate.

Once the winning ticket code has been verified and the system has qualified the winning contestant, for instance by fulfilling age and consent requirements if necessary, the winnings are paid out to the contestant 24, subject of course to any sharing arrangements with social media friends.

Upon successful verification of the sales documentation, the message displayed on the prize-winning menu item will change to display a message to the effect that the win has been successfully verified, for instance from “pending verification” to “get coupon code” or “approved” or the like. The contestant can then send a request, via the system 10, to activate her winnings. For instance, the contestant could request to be sent a OTP (One Time PIN) to release the coupon code, airtime voucher, e-wallet PIN, verification code or the like, as the case may be.

Prize winners may be required to sign an acknowledgement of receipt of the prize and when a minor wins a prize, the minor's legal guardian will need to sign a consent document authorising release of the prize.

For spot prizes, the verification process might possibly be reduced and simplified. In the spot prize verification process, a OTP could be issued to the contestant's mobile device and, only after the OTP has been input will a coupon code be issued to enable the contestant to redeem the stock price.

The system 10 can also be programmed to award spot prizes either randomly or for specific achievements during the course of a contestant participating in a competition. A spot prize screen may be used to allow a contestant 24 to see what spot prizes are on offer by selecting “prizes” from a pop-up menu on this screen. This pop-up menu will set out the available spot prizes, for instance 50 smartphones, 1000 airtime vouchers and 1000 soft serve ice-creams and the manner in which the spot prizes can be won. For instance, one smart phone is awarded for every millionth spin played within the competition; an airtime voucher is awarded every 10,000th spin played within the competition; and an ice-cream is awarded for every thousandth spin of that individual contestant.

Winnings can be paid out in a number of ways. For bonus winnings, for instance, the winning contestant 24 can be issued with a mobile coupon or a prepaid cellphone recharge voucher.

For jackpots and winnings involving larger amounts, the contestant 24 can be issued with an ATM PIN to withdraw the winnings at an ATM. The system 10 guides the contestant 24 through the security processes required to obtain such a PIN, using a number of screens, one of which might be a password screen. If the winnings exceed a certain limit, the system operator support staff might need to contact the winner and arrange a bank transfer after manual verification of Identity.

The system 10 is preferably configured such that the available prize money for a jackpot is allocated over the lifespan of the competition, so that the prize money is not exhausted before the competition ends. For example, if a competition runs for 6 weeks (40,000,000 seconds) and the promoter has a budget of R40,000 (40,000,000 cents) for prize money then the jackpot is programmed to increment at 1 cent per second. If someone wins the jackpot halfway through the competition when it has incremented to a value of R20,000, the jackpot will reset to zero and start incrementing again at 1 cent per second.

In a variation of this configuration, the system 10 could be configured, additionally, to have two components to the jackpot—a fixed portion and a variable portion. In such a variation (using the example above), the promoter 14 will introduce a further jackpot additional to the R40,000 fixed portion, to extend the jackpot if certain conditions are fulfilled or campaign objectives are met. For instance, the promoter 14 might extend the jackpot by R10 for each friend that is invited into the game; or by 10 cents if a banner ad is clicked; or by R1 if a contestant hits 10,000 spins; or by R10 for the millionth spin; or by R10 for special days, such as product or promoter anniversaries or “birthdays”; or by R100 If a goal of 1 million Facebook likes is reached, to name but a few examples. In-game notifications will be used to alert contestants 24 that the jackpot has been boosted. All of this information will be set out and explained in the “offer to participate”.

The additional jackpot is variable because it is determined by indeterminate occurrences. However, and since most promoters do not have unlimited budgets, the additional jackpot may be capped.

In such a variable jackpot version of the system 10, the variable jackpot could be a progressive jackpot, the system 10 being programmed to increase the jackpot as a function of the number of contestants 24 that join and play in a competition and the number of draw codes generated within the competition. The draw codes are a direct system response to contestants 24 playing the game—the more the game is played, the more the jackpot increases.

Alternatively, or in addition, the system 10 could be programmed to increase the jackpot as a function of the number of social media friends of a contestant who join in and participate in the competition.

Numerous variations of prizes, bonuses and winnings are possible. For some competitions, for instance where a retailer joins with a manufacturer to promote a particular product, contestants 24 can be requested to enter the number of their loyalty card issued by that particular retailer, in which case the jackpot is increased (for instance doubled) if they win. The added benefit of using a loyalty card is that proof of purchase might not be required, since the purchase data is available via the loyalty card number, thereby facilitating auditing of the ticket code associated with a loyalty card purchase.

When the jackpot is won, the system 10 notifies the entire game playing community on the system 10 that the jackpot in a particular competition has been won.

Another mechanism for introducing competition excitement is to extend the duration of a competition if certain conditions are fulfilled or campaign objectives are met. When the competition is about to expire, the system 10 may be configured to allow an extension of the competition by a predetermined number of days, for instance if a campaign objective is reached. For example, the promoter 14 might extend the competition by 3 days because 1 million click-throughs were achieved on a banner ad or because the promoters Facebook page achieved 1 million likes, to name but a few examples.

A further mechanism for introducing competition excitement would be to display the word “jackpot” on the display screen together with a prominent spin counter alongside the word “jackpot” on the play screen. In this embodiment of the invention, when the contestant 24 enters the contestant's first product code the contestant 24 is automatically allocated a certain number of additional or bonus spins. The system 10 is then programmed to reduce the spin counter by “1” every time the contestant 24 spins.

The use of a spin counter allows the inclusion of “spin boosters” in addition to the “jackpot boosters” described earlier. A spin booster is any contestant incentive that awards additional spins to the contestant 24. With such a spin booster, the contestant 24 requires more spins when the contestant 24 qualifies for a booster, for instance by entering a new product code, inviting friends or spinning a predetermined number of times.

The spin booster could be automatic or optional, for instance allowing the contestant 24 to choose whether to keep the booster as a spin booster and thereby obtain additional spins or to operate the booster as a jackpot booster that boosts the jackpot.

The system 10 may also be configured to include an “increment booster” function. This is a feature where the system boosts the jackpot for the achievement of major milestones, for instance all the contestants 24 in a particular competition together achieving 1 million Facebook “likes” during the course of the competition. Once again, the increment booster function could operate as a jackpot booster, a spin booster or both, depending on competition rules and the choice of the contestant 24

In all competitions, spins not used by a contestant 24 will normally fall away at the end of the competition. However, and as an alternative, the system 10 might be configured to record unused spins in the database against the player with a view to transferring unused spins to the next competition, which might suit large brand owners who run multiple related or unrelated competitions across multiple brands—unrelated competitions being related only through promotion by the same large brand owner.

The system 10 is not restricted to promotional competitions and also finds application as a means of introducing group gaming into online gambling, for instance slots, thereby providing, essentially, a social slots platform.

On virtual or digital slot machines, visual displays are used to emulate spinning reel-type slot machines on which virtual reels can be spun by means of a virtual button. A random number generator derives a random number for each reel corresponding to a stop on the reel. When spun, the machine directs the reels to stop on the spots selected by the random number generator.

The system is particularly suited to incorporate group gaming into progressive jackpot online slots. In progressive jackpot games, a percentage of each wager goes towards increasing the jackpot.

To play progressive jackpot online slots by way of a variation of the system configured as a progressive jackpot online slots platform, a contestant 24 registers on the system in the normal manner as described above and then invites the contestant's friends as described above, to form part of the contestant's group. In a paid gambling game, the contestant 24 will be required to pay for a ticket code that will enable the contestant 24 to register on the system.

Each time the contestant 24 logs on to the social slots platform, the system assigns the contestant 24 a randomly generated number derived from the contestant's ticket code (the equivalent of the contestant's ticket code in the promotional competition system 10 described above).

In the preferred form of this embodiment of the invention, the contestant 24 is assigned only one ticket code per session. When the contestant 24 logs off and then logs in again, the social slots platform assigns the contestant 24 a different ticket code.

When the contestant 24 presses “spin” the slots platform compares the draw code to the contestant's ticket code.

If there is an exact match between the contestant's ticket code and the draw code, the slots platform programmable logic instructs the virtual reels to stop at a jackpot indicator, for instance with each reel displaying the word “WILD”, paid out the jackpot and simultaneously resets the progressive jackpot to zero or a predetermined minimum amount.

If there is no match, the slots platform compares the draw code with the ticket codes of the contestant's friends. The system is preferably programmed to check only for the contestant's friends who are online at the time. In other words, the contestant and these friends need to play together. Once again, an indicator such as a green dot can be used to indicate that the contestant's friends are online.

If there is an exact match between the draw code and the ticket code of one of the contestant's friends, the slots platform 10.1 programmable logic instructs the virtual reels to stop at a jackpot indicator, for instance with each reel displaying the word “WILD”, pays out the jackpot and, simultaneously, resets the progressive jackpot to zero or a predetermined minimum amount. In addition, the system will send an in-system notification to both players that the contestant's friend hit the contestant's draw code.

The winning jackpot is shared between the contestant and the friend in the manner determined in the rules of the game.

On a virtual slots display, the virtual reels are rendered on screen to show reels within reel windows. When the reels come to a stop, the set of symbols located centrally of the reel windows are referred to as the “pay line”. In a refinement of the system 10, the virtual reels are rendered on screen to show parts of the symbols on either side of the pay line—just enough of the symbol before and the symbol after the pay line is shown for the contestant 24 to make out what the symbol is. This type of display makes use of the so-called “near-miss” principle. In the preferred implementation of this embodiment of the system 10, the reel spinning algorithm is weighted to spin the reels in such a manner that the symbols on two reels match quite frequently but the symbol on the third reel stops either above or below the pay line. This creates the impression that it is easy to hit the first and second bars and difficult to hit the last bar, but the apparent near miss induces the contestant 24 to spin again.

Such a display finds particular application in the awarding of spot prizes and in the preferred form of this embodiment of the invention, the symbols on the reels include spot prize symbols.

The system could be programmed, to bring up a progress screen that introduces a short excitement delay during the course of which the contestant 24 is informed that the system 10 is checking for a win—in essence checking the contestant's draw code against the contestant's ticket code. If the contestant has social media friends who have joined the competition, the system also brings up a second progress screen to inform the contestant 24 that the system 10 is also checking whether the contestant's spin matches the ticket codes of the contestant's social media friends.

To further incentivise contestants 24, the system 10 includes a system of in-game notifications. These in-game notifications are primarily associated with events in the game around winning prizes, for example:
“Keep spinning. You are halfway to winning a [prize name]” or
“the heat is on! 950,000 spins. Who will win the [prize name] for the millionth spin?”.

In game announcements may be automated by the system which is preferably programmed to issue in-game announcements after every predetermined number of spins, commencing from a predetermined spin total. For example, if the notification interval is set at 10,000 spins and the starting point is 950,000 spins, the second automated notification in the example above might state:
“the heat is on! 960,000 spins. Who will win the [prize name] for the millionth spin?”

Notifications are also used to inform a contestant that they have boosted the jackpot or won a prize or won spin credits. In these cases, the notifications have a “share” button which allows the contestant to post the notification to social media, for instance by posting on their Facebook timeline or sharing the notification on Twitter by way of a tweet.

In-game notifications and messages generated in a competition are independent of promoter marketing communications and will appear on the spin screen of every contestant in that competition regardless of whether the contestant 24 chose to opt in or out of receive the marketing communications from the promoter 14. However, any other promotional material, such as promoter marketing email or SMS notifications, will only be sent to those contestants who opt in to receive such promotional material.

In addition to in-game notifications, the system 10 may be configured to send notifications to users registered on the system, advising them of forthcoming competitions and competitions about to start.

Various mechanisms are available to increase excitement during the playing of any game or competition. For instance, certain of the screens used in the game user interface may be configured to include a progress bar, which is a graphical element used to visualize the progression of one or more in-game processes. A number of such progress bars can be included, such as a bar displaying the contestant's progress towards achieving a spot prize or a time bar displaying the time remaining in the completion that will alert contestants to the fact that time is running out for the competition, graduated in different colours to indicate how close to the end of the competition the contestant is. For example, the progress bar could, following a traffic light template, be green for the first half of the competition, yellow for the third quarter of the competition and red for the last quarter of the competition, thereby creating a sense of urgency to drive more people to play the game or competition.

Another such mechanism is the use of in-game announcements that notify contestants by way of pop-up messaging or push notifications. Examples of in-game announcements are: when a contestant's friend joins the game; when a contestant's friend wins; when someone wins the jackpot; a milestone that is achieved, for instance the millionth spin; possible changes in the competition introduced by the promoter 14, for example an increase in the jackpot or the start of another competition.

The system 10 also includes a chat function that makes use of a group chat window in the form of a chat display screen (FIG. 9WW) that displays the chats and replies of the contestants in a group. The chat functionality is only available to members within a group and allows group members to communicate freely amongst each other, the principal and being to encourage each other to achieve the group prize targets while playing the game.

A chat ticker function is also provided that displays, on the spin screen (FIG. 9BB), the latest message appearing on the group chat window. On the spin screen, the contestant 24 can press a chat reply button which brings up the group chat window. When a new message is displayed on the chat window, the chat ticker refreshes with the new message. The function of the chat ticker is to keep the attention of the contestants 24 centered on the play screen.

The system 10 includes a number of badges and trophies that contestants 24 can earn while playing competitions on the system, based, for instance, on the number of friends in their group, amounts contributed towards jackpot boosters or the number of jackpot or spot prize wins or the number of spin credits won.

An example of a trophies window is given in FIG. 9YY. By clicking on their own photo on the “invite friends” screen a contestant can determine what is required to acquire the trophy and track her progress towards achieving each of the different trophies. Clicking on a trophy displays trophy details including the requirements for winning the trophy—for example “the nerd” trophy requires a contestant to have 2 friends playing and “the fanatic” trophy requires a contestant to have reached 10,000 spins. In addition, the trophy details display shows the progress made by the contestant in acquiring the trophy—in the case illustrated, the contestant has fulfilled 2 out of the 2 requirements for accumulating the nerd trophy, hence 2/2 is displayed. This could also be displayed by way of a progress bar. When the trophy is awarded, the indicated status of the trophy changes from “award” to “awarded”.

The function of trophies is to provide players with a mechanism to recognise and be recognised by their co-contestants and friends for contributing. The display of trophies also means that more friends will choose to invite a contestant with many trophies to join their groups. The trophies incentivize contestants to participate in the various competitions. Firstly, they provide contestants with a target or goal to work towards, secondly they give the contestant recognition by the community on the platform for achieving milestones by way of in-game notifications when trophies are won and thirdly they help contestants decide which friends to invite into their groups. When inviting friends to join her group a contestant can see how active the friend is in playing on the platform by clicking on each friend in the “friends playing Thumbingo” section of the “invite friends” screen and reviewing the trophies that they have acquired and their progress towards acquiring additional trophies. Friends with more trophies are more likely to help contestants win prizes than friends with fewer trophies.

The system 10 is preferably programmed to retain contestants' trophies so that contestants 24 do not lose their trophies when a competition ends and trophies are thus carried over from one competition to the next.

As indicated above, online media provide a potentially rich communication interface which current competition systems fail to exploit in full.

The system of this invention seeks to change this by actively involving the competition contestant in playing the competition from the moment they enter the competition to the time that the competition expires. While the contestants play the competition, the system of the invention exposes them to targeted advertising. During the lifespan of any one competition, a contestant could be exposed to hundreds of hours of advertising. Additionally, the invention is a social platform where contestants can invite and play with (and for) their friends, with a constant exchange of information between the platform, the promoter, the contestants and their friends and with social media further driving excitement for the competition and for the competition promoter's brands.

The system also creates a platform to create and cement audience loyalty to ensure pre-authorised entrants for future competitions, for future promotional communications, and competitions from the brands of the various promoters.

1. A competition management system configured to host and administer multiple competitions each of which is configured to allow a plurality of contestants to participate in competing for rewards in the competition by means of system client devices operated by the contestants, the system comprising:
a host application server including programmable logic means programmed to receive, store and process competition data pertaining to multiple competitions each administered by at least one competition promoter on one or more system client devices operated by the promoter in accordance with predetermined competition rules;
a communications interface for the communication of data between the application server and system client devices operated by contestants, each including programmable logic means, a communications interface and a user interface;
the system being configured:
to issue an invitation to the system client device of at least one social media friend of a contestant to join the contestant in the competition by way of a system client device operated by the social media friend;
to create, in the host application server, an association between the contestant and the social media friend upon acceptance of the invitation by way of the system client device of the social media friend; and
to share at least one of the rewards awarded in the competition between the contestant and at least one social media friend associated with the contestant in the competition in accordance with predetermined reward sharing parameters.

2. The competition management system of claim 1 which includes means to allow the contestant to execute plays in the competition, the system using the contestant's system client device, the system being configured, upon execution of a play:
to award a reward to the contestant if, as a result of the executed play, the contestant fulfills the requirements of the competition rules for the reward; and
if, as a result of the executed play, the contestant does not fulfill the requirements of the competition rules for a reward, to determine whether a social media friend associated with the contestant fulfills the requirements of the competition rules for a reward; and
if the social media friend does fulfill the requirements of the competition rules for a reward, to award the reward to the contestant and the social media friend in accordance with predetermined sharing parameters.

3. The competition management system of claim 2 including:
means to generate and issue a promotional code specific to a particular competition to a prospective contestant in that competition;
means to permit the contestant, by way of the contestant's system client device, to participate in the competition by entry of the promotional code into the system and to execute plays in the competition;
means to derive a ticket code from the promotional code and to store one or more ticket codes as playing credits allocated to the contestant for purposes of playing the competition;
means to generate a random draw code each time the contestant executes a play in the competition;
means to compare the draw code to the contestant's stored ticket codes;
if the draw code matches a stored ticket code of the contestant, to award the reward to the contestant;
if the draw code does not match a stored ticket code of the contestant, to compare the draw code to the stored ticket codes of social media friends associated with the contestant;
if the draw code matches a stored ticket code of a social media friend of the contestant, to award the reward to the contestant and the social media friend in accordance with predetermined reward sharing parameters.

4. The competition management system of claim 3 including means to increment and decrement the playing credit allocated to a contestant in accordance with the competition rules, the system being configured to allow a competition promoter to include competition rules that allow a contestant to increment playing credits by inviting social media friends to play the competition collaboratively with the contestant.

5. The competition management system of claim 1 including means to facilitate the administration of competition-playing contestants affiliated in groups that, together, play collaboratively in the competition, the system including a scheme of counters, comprising:
for each contestant in a competition, an individual counter that tracks the executed plays of that contestant in a competition, regardless of group affiliation;
for each contestant in a competition, a friends counter that tracks the executed plays of that contestants that contribute towards the total number of plays executed by all the contestants in the group;
one or more group counters, each derived by calculating the sum of the friends counters of all the contestants in the group, the group counter values being in one or more group counter registers; and
a competition totals counter which is derived by calculating the sum of the friends counters of all the contestants in a competition.

6. The competition management system of claim 5, configured to allow a competition promoter to include competition rules that restrict the award of rewards in the competition by the inclusion, in the system, of means to reset any one or more of the counters to a predetermined lower level.

7. The competition management system of claim 1, configured to accumulate a progressive jackpot as a reward, the system being configured to increment the value of the jackpot in predetermined increments over the duration of the competition.

8. The competition management system of claim 7, configured to include a variable jackpot as a reward, the system being configured to allow a competition promoter to implement a scheme of jackpot variables constituted by rules that require a contestant to fulfill predetermined requirements to vary at least the value of the jackpot.

9. The competition management system of claim 1, configured to present a competition playing interface to the contestant on display means of the contestant's system client device, the playing interface being configured to resemble a three-reel slot machine playing interface, including three virtual spinning reels in a reels window and a virtual spin button configured, when pressed by a contestant in use, to cause the reels in the reels window to spin virtually.

10. The competition management system of claim 7 in which playing credits are stored and displayed as spin credits, the system being configured to decrement the contestant's spin credits with every press of the spin button and to prevent the contestant from playing the competition if the contestant's spin credits are exhausted.

11. A game management system configured to host and administer a progressive jackpot online slots game configured to allow a plurality of contestants to participate in competing for the jackpot in the game by executing plays on system client devices operated by the contestants each including programmable logic means, a communications interface and a user interface, the system comprising:
a host application server including programmable logic means programmed to receive, store and process game data pertaining to the game;
a communications interface for the communication of data between the application server and the system client devices operated by contestants;
the system being configured to issue an invitation to the system client device of at least one social media friend of a contestant to join the contestant in the game by way of a system client device operated by the social media friend and to create, in the host application server, an association between the contestant and the social media friend upon acceptance of the invitation by way of the system client device of the social media friend;
the system including programmable logic means configured:
to issue a slots game ticket code to a prospective contestant to enable the contestant to play the game; preferably by way of a communications channel external to the system;
means to increment the jackpot every time a slots game ticket code is issued to a prospective contestant;
to permit the contestant, by way of the contestant's system client device, to participate in the game by entry of the slots game ticket code into the system and to execute plays in the game;
to store one or more slots game ticket codes associated with the contestant;
to generate a random draw code each time the contestant executes a play in the game;
to compare the draw code to the contestant's stored slots game ticket codes;
to determine, if the draw code matches a stored slots game ticket code of the contestant, that the contestant fulfills the requirements of the game rules for winning the jackpot and to award the jackpot to the contestant;
if the draw code does not match a stored slots game ticket code of the contestant, to compare the draw code to the stored slots game ticket codes of social media friends associated with the contestant;
if the draw code matches a stored slots game ticket code of a social media friend of the contestant, to determine that the contestant and social media friend, in combination, fulfill the requirements of the game rules for winning the jackpot and to award the jackpot to the contestant and the social media friend in accordance with predetermined sharing parameters.
